(19) United States
(12) Patent Application Publication
(10) Pub. No.: US 2015/0278845 A1
(43) Pub. Date: Oct. 1, 2015

(54) System and method for presenting loyalty offers at a point-of-sale

(71) Applicants: Steve K. Sorem, Mechanicsburg, PA (US); Douglas A. Filak, Kennett Square, PA (US); Donald H. Schmitt, Greenville, DE (US)

(72) Inventors: Steve K. Sorem, Mechanicsburg, PA (US); Douglas A. Filak, Kennett Square, PA (US); Donald H. Schmitt, Greenville, DE (US)

(73) Assignee: JP Morgan Chase Bank, New York, NY (US)

(21) Appl. No.: 11/447,031

(22) Filed: Jun. 6, 2006

Related U.S. Application Data
(60) Provisional application No. 60/687,315, filed on Jun. 6, 2005.

(51) Int. Cl. G06Q 30/02; G06Q 20/20

(52) U.S. Cl. CPC G06Q 30/0226; G06Q 30/0224; G06Q 30/0238; G06Q 20/202

(57) ABSTRACT

A system and method for remote data access of customer loyalty information, said data being used to locally display a loyalty offer. The method comprising the steps of: detecting the presence of a customer at a merchant's location (store or web site) via an identifier, wherein the identifier is associated with and enables the customer to accumulate merchant value from a plurality of merchants based on the customer's behavior; generating customer, reward program, and/or general information at a remote location based on the identifier; and identifying at least one relevant merchant loyalty offer based on the customer, reward program, and/or general information, wherein the at least one relevant merchant loyalty offer is consortium-based; offering the customer or a designee of the customer at the merchant's location at least one of the at least one relevant merchant loyalty offer.

### RELATED APPLICATIONS

This application claims priority to U.S. Provisional Patent Application Ser. No. 60/687,315 filed Jun. 6, 2005 and titled “System and Method for Facilitating Point-of-Sale Loyalty,” the disclosure of which is incorporated herein by reference in its entirety.

### FIELD OF THE INVENTION

The present invention relates to reward programs that enable customers to induce customer loyalty. More particularly, the present invention relates to systems and methods that identify and present to customers loyalty offers based on customer, reward program, and/or other relevant information.

### BACKGROUND

Merchants use rewards programs and other incentives to attract and retain customers. For instance, merchants may provide incentives (e.g., rebates or discounts) on specific items purchased at their store or online web site. In some cases, merchants may apply the incentives at the point of sale (POS) and charge the customer a discounted amount for the purchased item. For rebates, customers may earn the rebate by purchasing a designated item, and the rebate may be redeemed at the POS of the designated item. Alternately, the amount of the rebate may be distributed to the customer sometime after purchase. Merchants also distribute coupons via newspaper, email, and other distribution channels, such as distribution at the POS. Some incentives enable customers to earn free items after making a specified number of purchases, e.g., over a specific length of time. For instance, a restaurant may offer a free sandwich if a customer purchases four different sandwiches during the month of August. After satisfying the terms and conditions of any incentive offer, customers may use these and other coupons towards the purchase of items, e.g., items at the merchant store. The coupon may be redeemed at the point of sale (POS).

Coupons and other benefits also provide incentives for the customer to purchase future items from the merchant. For example, customers may return to the merchant in order to redeem a previously-earned rebate or award, or to earn a subsequent rebate or award. Other things being equal, the more visits and purchases from a specific merchant and/or merchant store, the more “sticky” or loyal that customer will be to the merchant. This is partly because repeated contact engenders greater familiarity and knowledge of the merchant's product and store, which facilitates the shopping experience. Further, people will often return to a store merely out of habit.

Although conventional systems and methods enable merchants to provide customer incentives to create loyalty (e.g., “stickiness”), these incentive programs are typically untargeted and unfocused offers to the public. The rewards are typically delivered without taking into account particulars of the customer or his established transaction record. Further, rewards are not delivered to the customer in a real-time or “just in time” manner. As a result, many potential opportunities to reward customers and thus create loyalty go unrealized and unfulfilled.

Thus, what is needed is a reward system and method that better focuses on the particulars of customers to better motivate them to purchase from particular merchant(s).

### SUMMARY OF THE INVENTION

According to the various embodiments, systems and methods are disclosed for accessing data remotely to facilitate or encourage POS loyalty. In some embodiments, an identifier—e.g., card—may be used at the POS of any merchant(s) to accumulate merchant points, which in turn may be used to make purchases (e.g. a product at POS may be purchased with cash/value or merchant points, such as airline miles, for example). In some embodiments, the card or identifier may be presented at the POS (e.g., a kiosk or to the sales agent), where information about the customer may be obtained, accessed or provided. For example, customer information from the card or identifier may be used to induce different behavior (e.g., though customer always goes to restaurant for breakfast, can provide incentive to go for lunch or dinner). Similarly, the system may pull-up a pre-determined number of previous customer purchases/orders (e.g., last three purchases) to help the customer decide what he/she wants.

In some embodiments, an identifier may comprise a card, any biometric (e.g, finger or palm print or retina scan), an RFID device, a bar code, a telephone number, an address, a username and password, or any other alpha-numeric character or sequence thereof that may uniquely identify an individual, entity, or group of individuals or entities for purposes of generating and presenting loyalty offers as described herein. An identifier may be input into a device (e.g., kiosk, terminal, credit card processing terminal, ATM, or any other like device) at a merchant's location, for example, in order to indicate the presence at such location of the individual, entity or group of individuals or entities.

In some embodiments, the various systems and methods described herein may utilize customer, merchant, location, purchase/transaction, order data/information to determine particular offers to present to a customer. In addition, the various systems may utilize time-of-day processing (e.g., if it's morning, a certain customer order is initiated; if it's afternoon, another order is initiated, etc.), as well as customer demographics. The various systems and methods are well-suited for use in high frequency environments. Also, the various systems and methods may comprise an “on me” features whereby one user pays for all purchases orders.

In some embodiments, loyalty offers are determined based on product information as determined by SKU number or an Electronic Product Code (EPC), for example. Thus, if a customer walking into an automobile store and buys a headlight for a certain model truck, the various systems and methods described herein may generate and present a coupon for a discount oil change at a repair shop located in the vicinity of the customer's home address.

In some embodiments, geographic information may be used to target loyalty offers. For example, if a user withdraws funds from an ATM located on the corner of Main Street and First Avenue, the systems and methods described herein may generate and delivery loyalty offers to the user at the ATM that may be redeemed merchant's located in the vicinity. In some embodiments, the loyalty offers may be printed on the withdrawal receipt provided to the user after the withdrawal. Other delivery techniques are possible.

In some embodiments, hierarchical merchant structures may be defined and used to generate and present loyalty offers. That is, merchants may be defined according to predetermined hierarchies that specify particulars about the merchants as regards the distribution of relevant loyalty offers. For example, a top level hierarchy may correspond to a particular holding company. The next level of the hierarchy may correspond to individual lines of business within the holding company. The next level of the hierarchy may further divide the lines of business into chained-owned stores (e.g., company-owned) and franchisee-owned stores, for example. The next level, or bottom level, for example, may specify the geographic locations of each store within the lines of business. In some embodiments, data in the hierarchical structure may be defined by any parameter that may serve to distinguish any merchant or layer in a hierarchical structure, such as geographic location, size of company, type of company, and, for example. For example, a hierarchy layer may divide the chain-owned stores into NW, NE, SE and SW locations. Other hierarchy level definitions are possible.

In some embodiments, a loyalty offer or promotion, for example, may be offered at any level of a hierarchy. Thus, a $1 off coupon may be offered those stores that are located in a particular geographic location (e.g., particular city, state, region, etc.). Similarly, offers may be based on whether a store is chained-owned or franchisee-owned, for example, or based on the name of the store, for example. In some embodiments, offers may be presented at a terminal level. For example, if a customer is in the jewelry section of a department store, a different relevant loyalty offers may be presented than if the customer was in the men's department. Numerous other offer presentation schemes are of course possible.

In some embodiments, consortium loyalty offers or promotions may also be offered via the various system and methods described herein. For example, a customer walking into a particular retail store, may be presented with a loyalty offer that may be redeemed at another merchant, such as a restaurant, retail store, or online web site, for example. In some embodiments, a consortium promotion or entity may comprise combining any layer(s) of a hierarchy with the layer(s) with any layer(s) of another hierarchy to form a single loyalty offer or promotion, for example.

In some embodiments, the various systems and methods described herein enable two general features: (1) the ability to redeem “in-line” the current transaction in real-time (e.g., merchant gets real-time feedback regarding customer or transaction.), and (2) ability to target relevant loyalty (e.g., relevant to the customer's preferences).

According to one embodiment of the invention, a method for remote data access of customer loyalty information, said data being used to locally display a loyalty offer is provided. The method comprising the steps of: detecting the presence of a customer at a merchant's location (store or web site) via an identifier, wherein the identifier is associated with and enables the customer to accumulate merchant value from a plurality of merchants based on the customer's behavior; generating customer, reward program, and/or general information at a remote location based on the identifier; and identifying at least one relevant merchant loyalty offer based on the customer, reward program, and/or general information, wherein the at least one relevant merchant loyalty offer is consortium-based; and offering the customer or a designee of the customer at the merchant's location at least one of the at least one relevant merchant loyalty offer.

In another embodiment of the invention, a system for remote data access of customer loyalty information, said data being used to locally display a loyalty offer is provided. The system comprising detection means for detecting the presence of a customer at a merchant's location (store or web site) via an identifier, wherein the identifier is associated with and enables the customer to accumulate merchant points from a plurality of merchants based on the customer's behavior; information generation means for generating customer, reward program, and/or general information at a remote location based on the identifier; identification means for identifying at least one relevant merchant loyalty offer based on the customer, reward program, and/or general information, wherein the at least one relevant merchant loyalty offer is consortium-based; and offer means for offering the customer or a designee of the customer at the merchant's location at least one of the at least one relevant merchant loyalty offer.

In yet another embodiment of the invention, a method for remote data access of customer loyalty information, said data being used to locally display a loyalty offer is provided. The method comprising the steps of: determining the cost of a transaction with a customer; generating customer, reward program, and/or general information at a remote location based on an identifier associated with the customer; identifying at least one relevant merchant loyalty offer based on the customer, reward program, and/or general information, wherein the at least one relevant merchant loyalty offer; offering the customer at least one of the at least one relevant merchant loyalty offer at a merchant's location; modifying the cost of the transaction according to the at least one relevant merchant loyalty offer if the offer is accepted by the customer; converting the modified cost of the transaction into universal, client-specific or consortium-based merchant points; and deducting the equivalent amount of universal, client-specific or consortium-based merchant points from the customer's account.

In another embodiment of the invention, a computer-usable medium for remote data access of customer loyalty information, said data being used to locally display a loyalty offer is provided. The computer-usable medium comprising: code for detecting the presence of a customer at a merchant's location (store or web site) via an identifier, wherein the identifier is associated with and enables the customer to accumulate merchant points from a plurality of merchants based on the customer's behavior; code for generating customer, reward program, and/or general information at a remote location based on the identifier; code for identifying at least one relevant merchant loyalty offer based on the customer, reward program, and/or general information; and code for offering the customer or a designee of the customer at the merchant's location at least one of the at least one relevant merchant loyalty offer.

In yet another embodiment of the invention, a system for remote data access of customer loyalty information, said data being used to locally display a loyalty offer is provided. The system comprising: a detection processor for detecting the presence of a customer at a merchant's location via an identifier at a point of sale device, wherein the identifier is associated with and enables the customer to accumulate merchant points from a plurality of merchants based on the customer's behavior; an information generation processor for generating customer, reward program, and/or general information at a remote location based on the identifier; an identification processor for identifying at least one relevant merchant loyalty offer based on the customer, reward program, and/or general information; an offer processor for offering the customer or a designee of the customer at the merchant's location at least one of the at least one relevant merchant loyalty offer; a transaction module for processing transactions between a customer and a merchant; a merchant points conversion for converting merchant points to enable the customer to complete transactions; and an offer creation module for creating the least one relevant merchant loyalty offer.

Other embodiments may also be considered.

### BRIEF DESCRIPTION OF THE DRAWINGS

FIG. 1 shows an exemplary system 100 for inducing customer loyalty, according to various embodiments of the invention.

FIG. 1a depicts an interrelationship between users of system 100, according to various embodiments of the invention.

FIG. 2 shows an exemplary system 200 depicting a relationship between merchant 110 and central reward station 105 of system 100, according to various embodiments of the invention.

FIG. 3 illustrates various exemplary modules that may be associated with central reward station 105, according to various embodiments of the invention.

FIG. 4 illustrates various data and information that may be used to generate and present loyalty offers to customers, according to various embodiments of the invention.

FIG. 4a illustrates two hierarchies that may be used to generate and present loyalty offers, according to one embodiment of the invention.

FIG. 4b illustrates a five-level hierarchy that may be used to generate and present loyalty offers, according to one embodiment of the invention.

FIG. 4c illustrates three consortium-based loyalty structures that may be used to generate and present loyalty offers, according to one embodiment of the invention.

FIG. 5 illustrates a process flow 500 for inducing customer loyalty, according to various embodiments of the invention.

FIG. 6 illustrates a process flow 600 for inducing customer loyalty, according to various embodiments of the invention.

FIG. 7 illustrates a process flow 700 for inducing customer loyalty, according to various embodiments of the invention.

FIG. 8 illustrates various exemplary loyalty offers 800 generated and presented by the systems and methods described herein.

FIG. 9 illustrates an interface 900 for setting up a loyalty offer for presentation to a customer, according to various embodiments of the invention.

FIG. 10 illustrates an interface 1000 for setting up a loyalty offer for presentation to a customer, according to various embodiments of the invention.

FIG. 11 illustrates an interface 1100 for setting up a loyalty offer for presentation to a customer, according to various embodiments of the invention.

FIG. 12 illustrates an exemplary loyalty offers 1200 generated and presented by the systems and methods described herein.

FIG. 13 illustrates an exemplary loyalty offers 1300 generated and presented by the systems and methods described herein.

FIG. 14 illustrates an interface 1400 for setting up a loyalty offer for presentation to a customer, according to various embodiments of the invention.

FIG. 15 illustrates an interface 1500 for setting up a loyalty offer for presentation to a customer, according to various embodiments of the invention.

FIG. 16 illustrates an interface 1600 for presenting a loyalty offer to a customer and receiving transaction information from the customer, according to various embodiments of the invention.

### DETAILED DESCRIPTION OF EXEMPLARY EMBODIMENTS

Reference will now be made to the present preferred embodiments of the invention, examples of which are illustrated in the accompanying drawings in which like reference characters refer to corresponding elements.

The present invention is described in relation to a system and method for inducing customer loyalty. Nonetheless, the characteristics and parameters pertaining to the system and method may be applicable to transactions associated with other types of reward programs.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Among many potential uses, the systems and methods described herein may be used to: (1) induce customer loyalty by identifying and presenting relevant loyalty offers based on customer behavior (e.g., past transactions), customer or merchant identity, location of the transaction, or any other data or information that may be used to particularize or focus relevant offers to enhance the likelihood of loyalty; (2) allow merchants to identify relevant particulars of a customer in order to identify and generate loyalty offers that may be of particular relevance or interest to the customer; (3) allow merchants to cross-market their products or services; (4) allow customers the ability to realize immediate and “just in time” rewards prior to consummation of a transaction with a particular merchant(s); (5) allow centralized coordination of multiple reward programs using universal, client-specific or consortium-based merchant points, for example, that may be accumulated and redeemed at any participating merchant; (6) track customer transactions and decision-making to enhance the resolution and precision of loyalty offers; (7) allow a third part (e.g., a bank or other financial institution) to administer and coordinate the generation and presentation of relevant loyalty offers; (8) track behavior and actions of an individual across a consortium of merchants (e.g., create a promotion based on a particular product SKU or EPC, for example, that generates a loyalty offer for a merchant other than the one where the product was purchased). Other uses are possible.

According to various embodiments, the systems and methods described herein may facilitate, encourage or induce point of sale (“POS”) loyalty based on particulars of the customer, the merchant or rewards program, or other relevant general information or data that may be used to identify particular loyalty offers that have, for example, a high probability of acceptance. In some embodiments, an identifier (e.g., card) may be used at the POS of any merchant(s) to receiving relevant information that may be used to identify such relevant loyalty offers and to accumulate universal, client-specific or consortium-based merchant points that may be used to make purchases at any merchant, for example. For example, a user walking into a merchant's retail store may swipe a card through a POS of sale device or terminal to indicate his presence and provide relevant particulars about himself, such as his identity, past transactions, personal designations (e.g., preferred merchants, products or services), and reward program data or information (e.g., the total number of earned merchant points or particulars on how such merchant points are redeemed.)

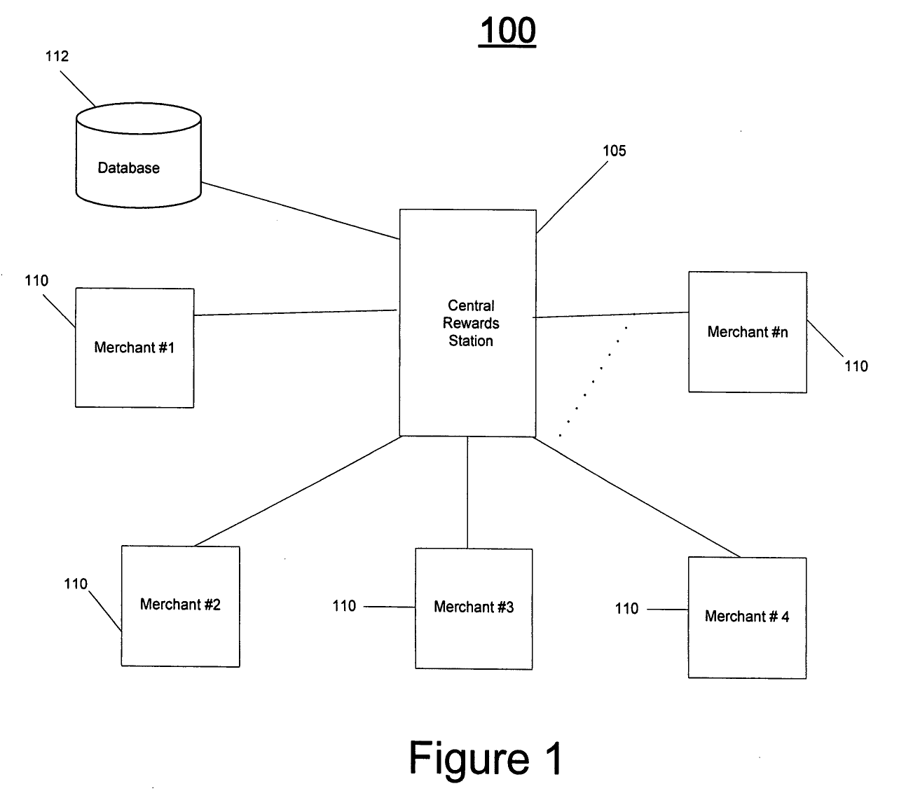

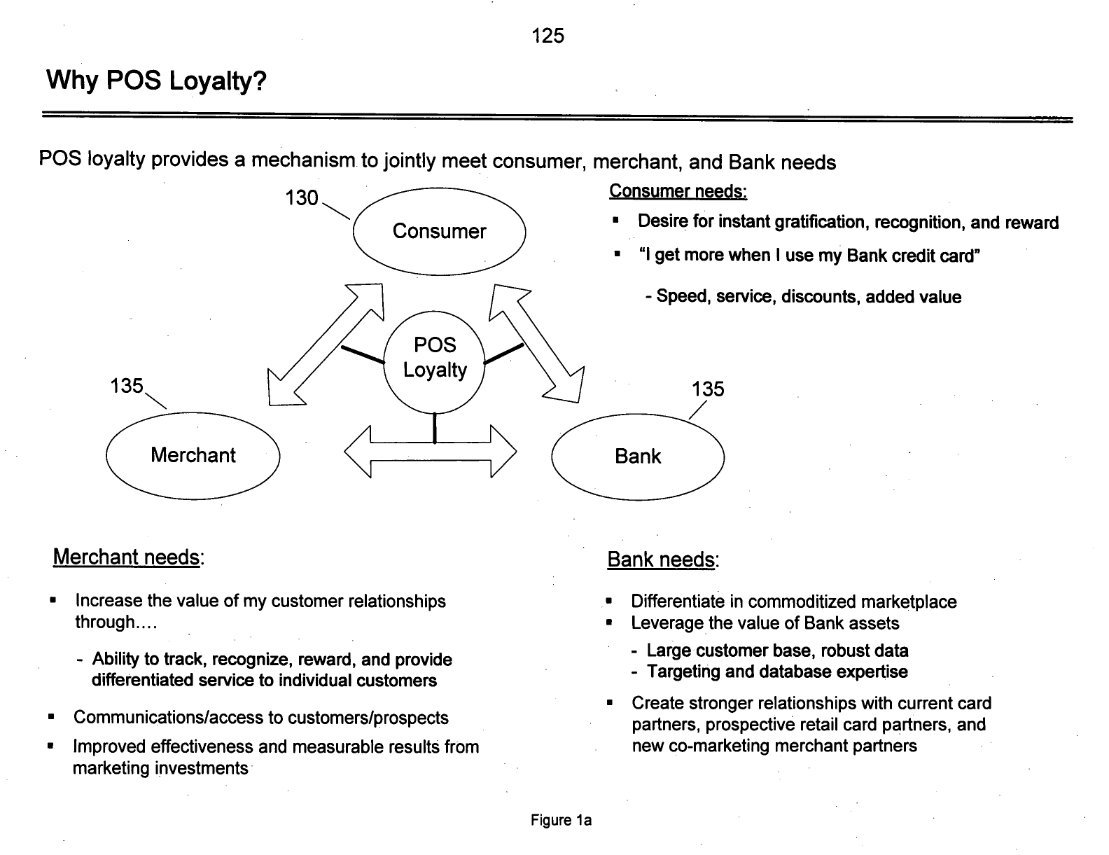

FIG. 1 illustrates a system 100 for inducing customer loyalty according to one embodiment of the invention. System 100 may comprise a central rewards station 105 for coordinating customer interaction and transactions with any of merchants 110. In some embodiments, central rewards station 105 may be administered by a bank, financial institution, or any third party that coordinates customer interaction with merchants 110 and any corresponding rewards programs thereof. In some embodiments, central rewards station 105 may maintain particulars about the customers of merchants 1-n 110, including the transactions entered into by the customers as well as maintain data and information about the merchants themselves, and any other data or information that may be used to induce customer loyalty.

Data and information maintained by central control station 130 may be stored and cataloged in database 112 which may comprise or interface with a searchable database. Database 112 may comprise, include or interface to a relational database. Other databases, such as a query format database, a Standard Query Language (SQL) format database, a storage area network (SAN), or another similar data storage device, query format, platform or resource may be used. Database 112 may comprise a single database or a collection of databases, dedicated or otherwise. In one embodiment, database 112 may store or cooperate with other databases to store the data and information used or generated by the various systems and methods described herein. In some embodiments, database 112 may comprise a file management system, program or application for storing and maintaining data and information used or generated by the various features and functions of the systems and methods described herein. In some embodiments, database 112 may store, maintain and permit access to customer information, merchant or reward program information, and general information used to induce customer loyalty, as described herein.

In some embodiments, system 100 may facilitate, induce or encourage customer point-of-sale loyalty at any of merchants 110 by providing, for example, real-time loyalty offers to such customers during particular transaction or experience. For example, a customer walking into the store of merchant #1 may be provided with a real-time offer for 10% off any purchase made that day or during the next few days. Other offers are of course possible. In some embodiments, a loyalty offer may be based of the customer's identity or past transactions, for example, as determined by an identifier associated with the customer. In some embodiments, an identifier may comprise a card, any biometric (e.g, finger or palm print or retina scan), an RFID device, a bar code, a telephone number, an address, a username and password, or any other alpha-numeric character or sequence thereof that may uniquely identify an individual, entity, or group of individuals or entities for purposes of generating and presenting loyalty offers as described herein. For example, a customer walking into merchant #1 may swipe his credit through a point-of-sale device, such as a kiosk terminal, for example, to provide information that may be used to generate loyalty offers that the customer may find appealing. In some embodiments, such information may be provided before the customer places an order (e.g., upon joining a queue at a restaurant or coffee shop), during placement of an order, or during payment (e.g., when the customer's credit card is swiped by the sales person at the time of payment). Thus, if the customer gets in line at a fast food restaurant, places an order with the sales clerk, pays for the food with his credit/debit/gift card, for example, relevant data and information may be obtained anytime during the process that may be used to identify relevant loyalty offers the may be of particular interest to the customer. Such loyalty offers may be presented to the customer before he places his order (e.g., via a kiosk terminal), while interfacing with the sales clerk (e.g., the clerk might present the loyalty offer verbally), or upon providing payment (e.g., the loyalty offer is printed on the sales receipt). Loyalty offers may be presented in other ways.

FIG. 1a depicts an illustration 125 showing the interrelationship between the various parties that are participants or users of system 100, namely: a customer 130, a merchant 135 and an administrator of central rewards station 105. In some embodiments, the administrator of central rewards station 105 may comprise merchant 135, another merchant, or any third party individual or entity that is responsible for administering the various features and functionality of system 100 and more particularly central rewards station 105 that are described herein. As shown, system 100 provides the following benefits for the customer, merchant and administrator.

For example, system 100 may enable the customer to achieve instant gratification, recognition and reward. For example, a customer visiting a merchant (either a retail location or a web site, for example) may, upon identifying himself via an identifier, obtain loyalty offers from the merchant for use at that time or within a predetermined period of time. Such offers may comprise coupons, rebates, discounts, merchant points (e.g., universal, client-specific or consortium-based), an automatic order, information, entry into a sweepstakes or lottery, or advertisement. Other types and forms of offers are of course possible.

System 100 may enable the merchant 135 to increase the value of customer relationships by providing the merchant with the ability to track, recognize, reward and provide differentiated service to individual customers based on, for example, the customer's identity, particulars about the reward programs (e.g., total number of merchant points accumulated) the customer is affiliated with, or any other data or information that enhances the merchant's ability to induce loyalty on a customer-by-customer basis. System 100 may also enable merchant 135 to communicate with customers and access particulars about them, as well as potential customers or prospects. For example, rather than providing a redeemable loyalty offer (e.g., rebate, coupon, discount, etc.), the merchant may provide information (e.g., about an upcoming sale) or advertisement about the merchant's (or other merchant's) products or services. This way, the merchant is able to promote its services and products, as well as cross-market with other merchants.

In some embodiments, system 100 may enable the administrator 135 to differentiate in a commoditized marketplace; leverage the value of their assets (e.g., if the administrator is a bank or a financial institution, it can leverage the value of its credit cards, debit cards, stored value cards, RFID device, accounts, or any other like product or service); develop targeting and database expertise; and create stronger relationships with current card partners, prospective retail card partners, and new co-marketing merchant partners.

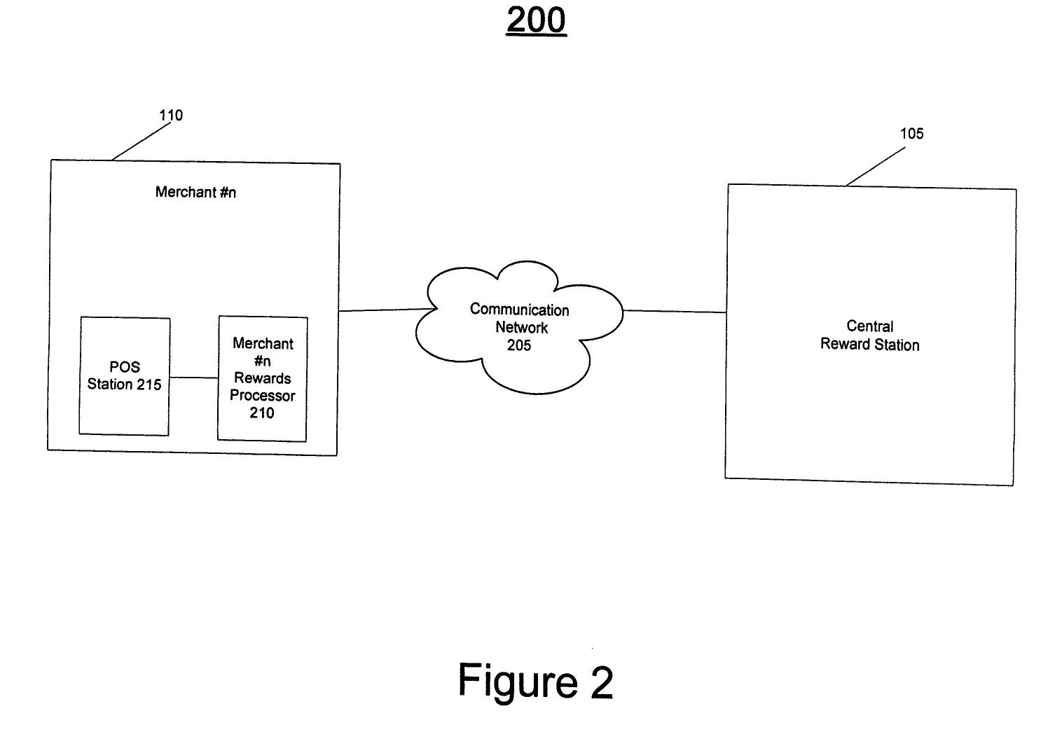

FIG. 2 depicts a system 200 illustrating the relationship between central reward station 105 and a particular merchant #n 110. In some embodiments, central reward station 105 and merchant 110 are connected via a communication network 205. Communications network 205 may comprise any type of communication network such as one able to transmit and receive data or information relating to loyalty offers, transactions, identity of customers and/or merchants, particulars about past transactions, for example. Other data or information may be communicated. Communications network 205 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection.

Communications network 205 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 205 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network 205 may comprise a satellite communications network, such as a direct broadcast communication system (DBS) having the requisite number of dishes, satellites and transmitter/receiver boxes, for example. Communications network 205 may also comprise a telephone communications network, such as the Public Switched Telephone Network (PSTN). In another embodiment, communication network 120 may comprise a Personal Branch Exchange (PBX), which may further connect to the PSTN.

As shown in FIGS. 1 and 2, central rewards station 105 may comprise the central headquarters or repository of the various features and functions of the systems and methods described herein. For example, central rewards station 105 may maintain data and information about each of merchants 110 (1-n) and their customers, including, for example, data and information on customer demographics, past transactions, preferred or favored merchants and products, and any other data or information that may used to generate and present loyalty offers as described herein. In some embodiments, central rewards station 105 is maintained by any party or entity that administers the coordination of data and information in connection with the generation and presentation of loyalty offers according to the systems and methods described herein. In some embodiments, such administration may comprise receiving and processing customer, merchant and/or transaction information to identify relevant loyalty offers that may be presented to a customer to induce additional loyalty with any particular merchant(s). In some embodiments, the administrative functions of central rewards station 105 may also comprise the processing of customer and merchant transactions based on merchant points, as well as maintaining accurate and up-to-date information about a customer and/or merchant's accumulated merchant points. Central rewards station 105 may also convert between different merchant point awards to facilitate a customer's redemption of such points regardless of the merchant.

Central rewards station 105 may comprise a single server or engine (as shown). In another embodiment, central rewards station 105 may comprise a plurality of servers or engines, dedicated or otherwise, which may further host modules for performing desired system functionality. central rewards station 105, for example, may host one or more applications or modules that function to permit interaction between the users of system 100 (e.g., merchants, customers, the administrator of central rewards station 105, and other relevant parties) as it relates to exchanging and processing of data and information related to the identification and generation of loyalty offers, for example. For instance, central rewards station 105 may include an administration module that serves to permit interaction between the system 100 and the individual(s) or entity(ies) charged with administering system 100 or central rewards station 105. For example, such an administration module may enable the agent of central rewards station 105, for example, to input information related to loyalty offers, including but not limited to parameters used to generate loyalty offers for presentation to a customer. Such parameters may comprise variables that define a particular pool or segment of customers that may be presented with a particular loyalty offer. Thus, a loyalty offer relating to a free breakfast order at a particular merchant may target groups of customers that routinely buy lunch at the merchant. This way, the merchant may induce additional loyalty from those customers by providing an incentive to visit the merchant for breakfast.

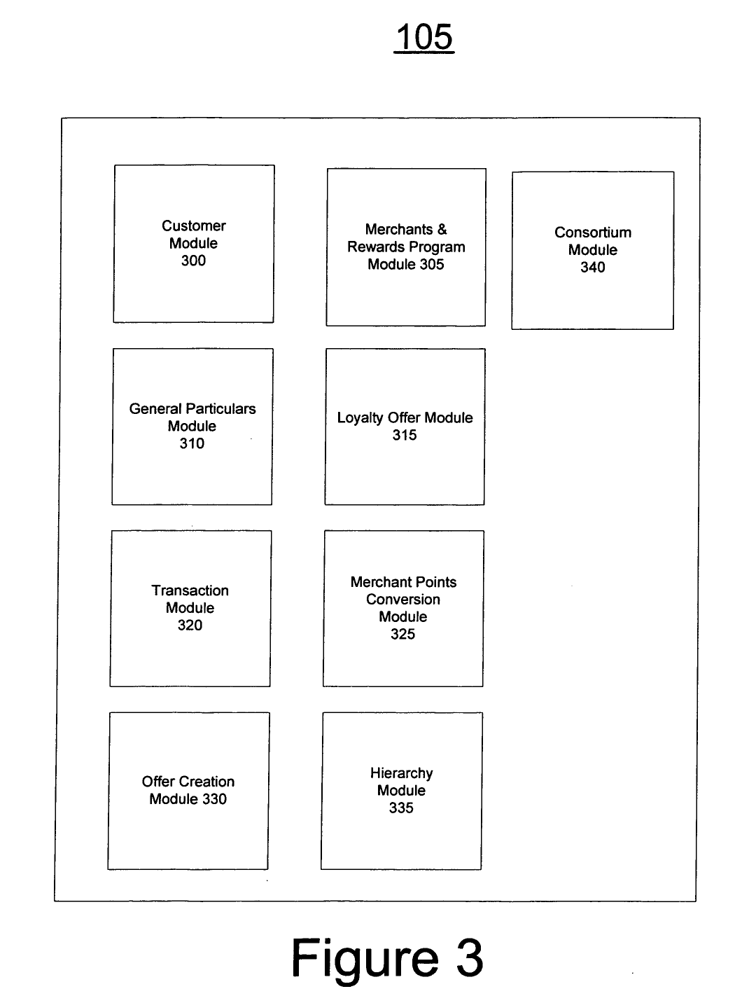

According to various embodiments, an agent of central rewards station 105 may interface with a graphical user interface (or GUI) to input: (1) data or information (e.g., terms, words, phrases, or digits) that enable the agent to define particular pools of customers, (2) data or information that enable the agent to define particular loyalty offers (e.g., the text to be displayed on the loyalty offer), (3) data or information that enable the agent define particular merchants through which the loyalty offers will be delivered, and (4) rules, parameters and algorithms used to identify which loyalty offers to present. An agent of central rewards station 105 may also input information or data regarding how loyalty offers may be stored in a database 112, for example. Other modules may permit users to access and view documents over a network which relate to a particular trade or financial transaction (See FIG. 3 for modules associated with central rewards station 105).

Central rewards station 105 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

As shown in FIG. 2, merchant 110 may comprise or maintain a proprietary or affiliated merchant rewards program that provides incentives for its customers. In some embodiments, such rewards program may maintain particulars on customers, such as their identities, purchase transactions, and amount of accumulated merchant points, for example. In some embodiments, such a merchant rewards processor 210 may provide the features and functionality associated with the rewards program.

Merchant 110 may also comprise or maintain a POS station 215 for enabling customer interaction with the merchant and/or the merchant rewards processor 210, and/or central rewards station 105. In some embodiments, POS station 215 may comprise a terminal or other device whereby data or information used to identify, generate and present loyalty offers as set forth herein. For example, POS station 215 may comprise a terminal associated with a kiosk, for example, that a customer may interact with upon entering a merchant's store. Such a terminal may comprise a touch-screen or keyboard or keypad that the user can interact with to perform any activity related to the customer purpose for visiting the merchant. In some embodiments, POS station may comprise a credit/debit card processing station or terminal through which a cashier may swipe a customer's credit or debit card. In some embodiments, POS station 205 may comprise a device or terminal that registers RFID devices that may be associated with a customer. For example, such an RFID device may be part of the user's credit or debit card, or a sticker or other element attached thereto. In some embodiments, the POS station 215 may comprise an ATM where a customer might withdraw funds.

In some embodiments, POS station 215 may comprise any terminal (e.g., a typical home or personal computer system) whereby a user may interact with a network, such as the Internet or any data network, such as communications network 205, for example, responsible for transmitting and delivering data and information used by the various systems and methods described herein. POS station 110 may comprise or include, for instance, a personal or laptop computer. POS station 110 may include a microprocessor, a microcontroller or other general or special purpose device operating under programmed control. POS station 110 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. POS station 110 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). POS station 110 may also include a network-enabled appliance, a browser-equipped or other network-enabled cellular telephone, or another TCP/IP client or other device.

POS station 110 may be utilized by a customer of a merchant to provide data and information used to identify, generate and present loyalty offers, conduct online transactions and purchases, and/or simply conduct online searches, such as through a search engine or site, for example, that may produce data and information indicative of user preferences or interests that may be used to further enhance the identification, generation and presentation of loyalty offers. For example, customer can interact with POS station 215 to input an order (e.g., for fast food) and thereby inform the merchant of the customer's preferences or likes. In some embodiments, a customer need not interact with POS station 215 to initiate the various features and functions described herein. For example, POS station 215 may also comprise a terminal or device operated by the sales clerk, for example, to process credit/debit/gift card payments from customers.

In some embodiments, POS station 215 may also present the customer with relevant loyalty offers. For example, if a customer visits a merchant and identifies himself through POS station 215, POS station 215 may then transmit this information to merchant rewards processor 210 and/or central rewards station 105 which in turn may identify, generate and present loyalty offers to the customer. In some embodiments, such loyalty offers may be presented to the customer via a terminal screen, a printed coupon or receipt, or verbally by a agent merchant (e.g., sales clerk).

In some embodiment, POS device 215 may track and monitory customer behavior or activity by receiving an identifier that is related to or associated with customer activity or behavior. Once obtained, the identifier may then be transmitted over communications network 205 to central reward station where it may be resolved against a database(s) to determine relevant loyalty offers or promotions that may be offered to the customer. In some embodiments, the identified loyalty offers are transmitted to the merchant's location, for example, for presentation to the customer, either through POS device 215 or otherwise. In some embodiments, the loyalty offers identified and presented may be part of a loyalty program associated with or administered by the merchant, while in some embodiments the loyalty offer may be from a program administered by a separate entity, such as a bank or other merchant, for example.

FIG. 3 illustrates exemplary modules that may be associated with central rewards station 105 for carrying out (or administering) the various functions and features of the embodiments described herein. In some embodiments, the modules may: (1) be accessed by an agent of central rewards station 105, (2) monitor the activities of a user interfacing with client station 110, and/or (3) coordinate with central rewards station 105 and/or sponsor or provider station 115 the identification and presentation of loyalty reward programs or offers to a user of client station 110. While the modules may not be used in all embodiments to perform some or all of the functions of the present invention, they are nonetheless presented as possible embodiments:

Customer module 300 may, in some embodiments, process and maintain data and information relating to the customer, such as, for example, the identity of the customer, the location (e.g., residential or work address) of the customer, the customer's preferred or favorite merchants, products or services, or any other demographic information that may be used to identify, generate or present relevant loyalty offers to the customer according to the systems and methods described herein.

Merchant rewards program module 305 may, in some embodiments, process and maintain data and information relating to the merchant and/or its rewards programs, such as, for example, the identity of the merchant(s), the number of merchant points earned (e.g., universal, client-specific or consortium-based), the types of merchants associated with the earned merchant points, past transactions fulfilled with merchant points, or any other data or information that may be used to identify, generate or present relevant loyalty offers to the customer according to the systems and methods described herein.

General particulars module 310 may, in some embodiments, process and maintain data and information relating to general particulars, such as, for example, the date and/or time of customer's presence at the merchant's location, the merchant's identity and/or location, the identity and/or location of at least one other merchant in the vicinity of the merchant, or any other data or information that may be used to identify, generate or present relevant loyalty offers to the customer according to the systems and methods described herein.

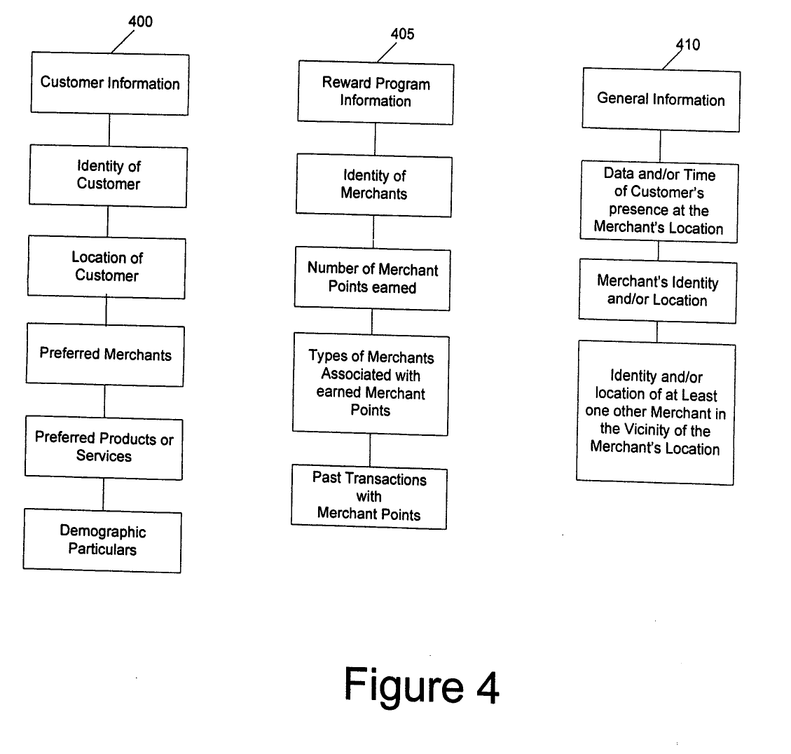

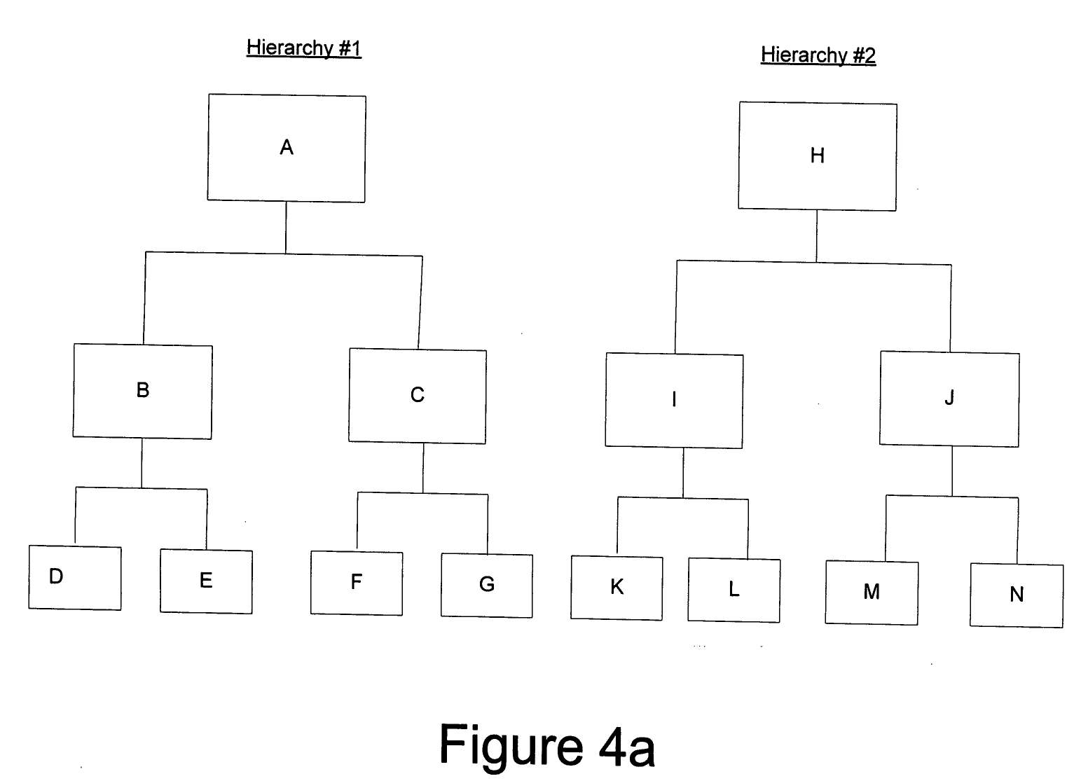

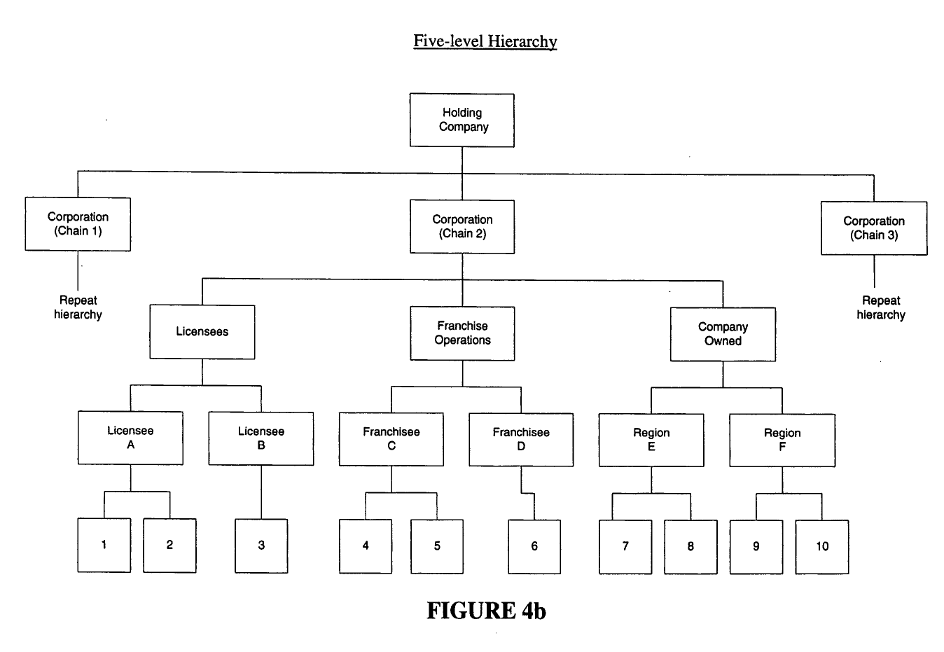

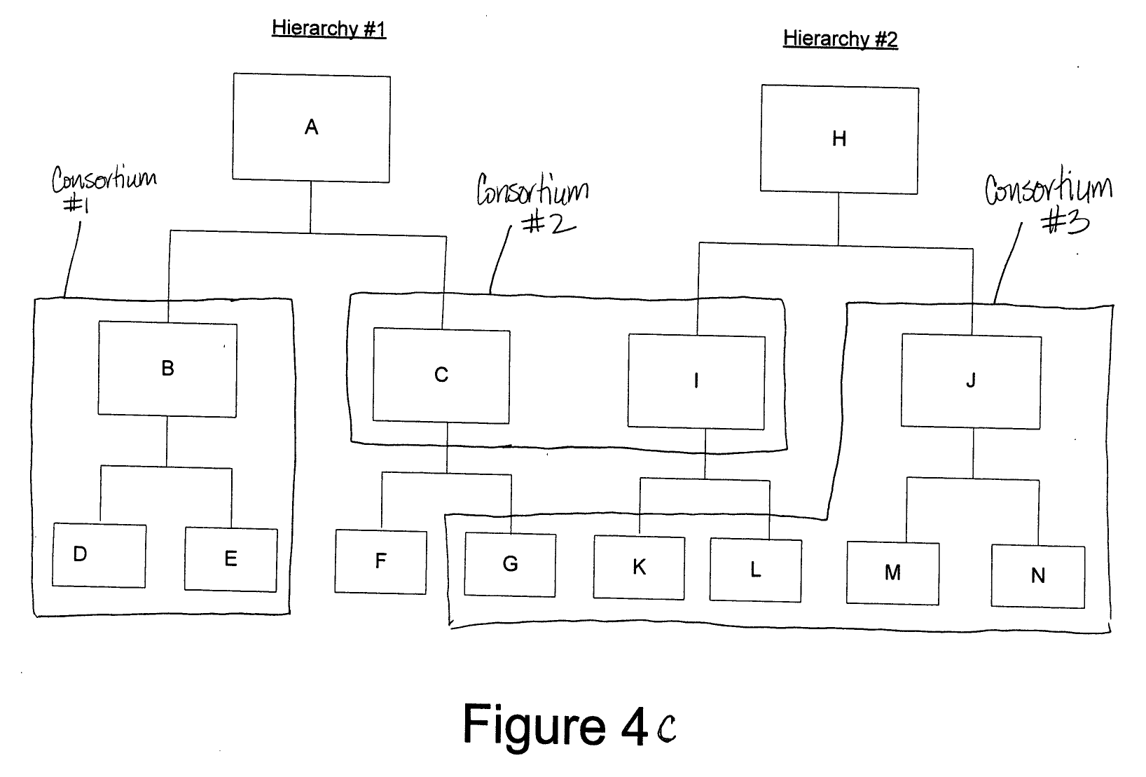

Loyalty Offer module 315 may, in some embodiments, identify, generate and present loyalty rewards programs based on customer information, merchant reward program information, and general information that may be used to identify and present loyalty offers to individual customers. For example, upon receiving customer, reward program and/or general information (e.g., See FIG. 4) from a POS station 215, for example, central rewards station 105 may resolve such information against rules or algorithms for identifying particular loyalty offers that are deemed to be of particular relevance or interest to the imminent transaction about to take place between a customer and a merchant. In some embodiments, such loyalty offers may be generated and maintained by the administrator of central rewards station 105 (see offer creation module 330).

Transaction module 320 may, in some embodiments, track, monitor and process transactions between a customer and a merchant. In some embodiments, such transactions may be conducted via an identifier that uniquely identifies the customer, such as a credit, debit, or gift card, any biometric information (e.g, finger or palm print or retina scan), an RFID device, a bar code, a telephone number, an address, a username and password, or any other alpha-numeric character or sequence thereof. For example, a user walking into a merchant's store may swipe his gift card to indicate his presence in the store and/or to pay for a particular order, product or service. Transaction module 320 may then record information obtained from the gift card and use it to present relevant loyalty offers or store it for future use in determining loyalty offers. In some embodiments, all information used to determine loyalty offers comes from the gift, while in some embodiments additional information may be obtained by resolving such data against a database to get more particular or granular information. For example, the act of swiping the gift card may provide the customer's name and location, which information can then be used to obtain additional information about the customer, such as his preferred merchants, products or services, for example.

In some embodiments, transaction module 320 may also reward and maintain merchant points based on customer transactions. In some embodiments, merchant points may be particular to the merchant where the transaction occurred, while in some embodiments the points may be in a common currency (e.g., universal, client-specific or consortium-based merchant points) that may be redeemed at any merchant. Transaction module 320 may maintain accounts for each customer which contain a merchant point balance, for example.

Merchant points conversion module 325 may, in some embodiment, facilitate customer transactions by converting merchant points based on predetermined exchange rates, for example. Thus, if a customer account indicates 100 merchant points corresponding to merchant A, but the customer buys a product from merchant B, merchant points conversion module 325 may convert the 100 merchant points into an equivalent amount of cash or merchant points for merchant B to enable the customer to fulfill the transaction. In some embodiments, merchant points conversion module 325 may also track and maintain transactions involving point conversions to enhance the determination of loyalty offers to present to customers. For example merchant points conversion module 325 may maintain information indicating that the customer repeatedly converts points from merchant A to purchase products from merchant B. This information may result in central rewards station 105 presenting a loyalty offer inviting the customer to join a rewards program associated with merchant B. Other scenarios are possible.

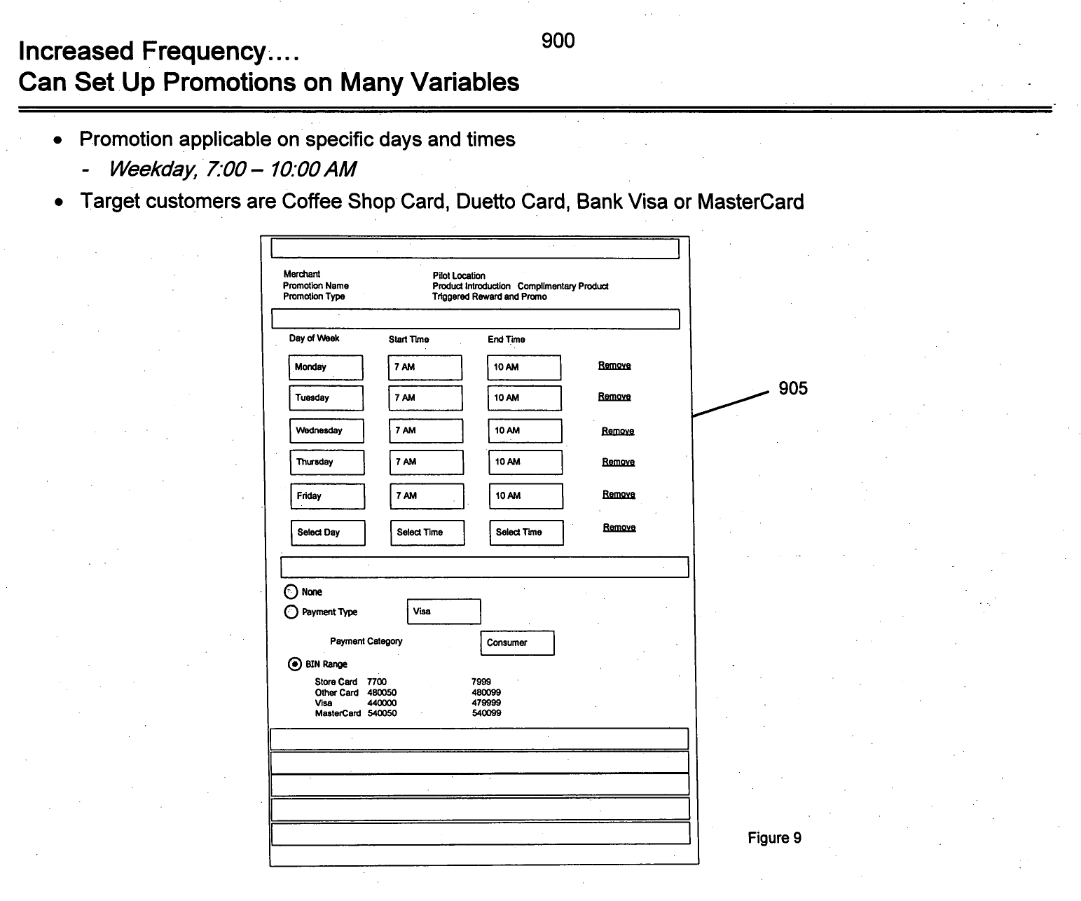

Offer creation module 330 may, in some embodiments, enable an administrator of central rewards station 105, for example, to create, edit and revise loyalty offers that may be presented to customers as described herein. In some embodiments, an agent of central rewards station 105, for example, may interact with various graphical user interfaces (GUI's) of offer creation module 330 to provide parameters that result in initiation of a loyalty offer if conditions are met. Exemplary interfaces are illustrated in FIGS. 9, 10, 11, 14 and 15.

Hierarchy module 335 may, in some embodiments, enable an administrator of central rewards station 105, for example, to create, define, edit and revise hierarchy structures that may be used to generate and present loyalty offers to customers as described herein. Exemplary hierarchy structures are set forth in FIGS. 4a and 4b.

Consortium module 340 may, in some embodiments, enable an administrator of central rewards station 105, for example, to create, define, edit and revise consortiums that may be used to generate and present loyalty offers to customers as described herein. Exemplary consortiums are set forth in FIGS. 4c.

FIG. 4 illustrates various data and information that may be used to generate and present loyalty offers to customers, according to various embodiments of the invention. In some embodiments, such data and information may comprise customer information 400, reward program information 405 and general information 410. For example, customer information 400 may comprise the identity of the customer, the location of the customer (e.g., residence, work address or present location), preferred merchants, products or services, or any other demographic particulars of a customer that may be used to identify and deliver relevant loyalty programs by the various systems and methods described herein. In some embodiments, customer information 400 may be generated by monitoring the customer's transactions with various merchants, and/or by querying the customer during, for example, the registration process for a particular rewards program, such as that administered by central rewards station 105.

In some embodiments, an administrator of central rewards station 105, for example, may provide a customer with a particular identifier, such as an RFID device, that the user may affix to his or her credit or debit card, for example, which the various systems and methods described herein may then use to generate and distribute loyalty offers and programs as described. In some embodiments, such RFID device may be associated with particular loyalty offers or promotions based on the customer's demonstrated shopping or transaction pattern(s). In some embodiments, a security check may be performed to ensure that the person using the RFID device, is the intended customer. For example, if the credit or debit card associated with the RFID is the one used to pay for the transaction, then this may confirm or validate the identity of the user. In some embodiments, the cashier may check the identification of the customer before validating the promotion or offer. Other techniques are possible.

Merchant reward information 405 may comprise the identity of merchants, the number of merchant points earned, points, the types of merchants associated with earned merchant points, past transactions involving merchant points, and/or or any other data or information that may be used to identify and deliver relevant loyalty programs by the various systems and methods described herein.

General information 410 may, in some embodiments, comprise the date and/or time of the customer's presence at a merchant's location, the merchant's identity and/or location, the identity and/or location of at least one other merchant in the vicinity, and/or or any other data or information that may be used to identify and deliver relevant loyalty programs by the various systems and methods described herein.

FIG. 4a illustrate two hierarchical merchant structures that may be used by the systems and methods described herein to generate and present loyalty offers. As shown, hierarchy #1 may comprise three levels. Level one includes merchant A. Level two includes merchants B and C. Level three includes merchants D, E, F and G. Hierarchy #2 also comprises three levels. Level one includes merchant H. Level two includes merchants I and J. Level three includes merchants K, L, M and N.

In some embodiments, merchants may be defined according to predetermined hierarchies that specify particulars about the merchants as regards the distribution of relevant loyalty offers. For example, the top level of hierarchy #1 may correspond to a particular holding company A. The next level of the hierarchy may correspond to individual lines of business B and C within the holding company. The next level, or bottom level, for example, may specify related merchants by geographic location, such as northern or southern regions of a particular state. For example, if merchant B is a particular restaurant chain, then D may identify merchant B's that are in the northern region, while E identifies those that are in the southern region. In some embodiments, data in the hierarchical structure may be defined by any parameter that may serve to distinguish any merchant or layer in a hierarchical structure, such as geographic location, size of company, and type of company, for example. Other hierarchy level definitions are possible.

In some embodiments, hierarchies of various levels may be used with the various systems and methods described herein. For example, FIG. 4b illustrates a five-level hierarchical merchant structure that may be used by the systems and methods described herein to generate and present loyalty offers. As shown, the five-level hierarchical structure comprises a first level containing a single holding company; a second level containing three chains of a corporation; a third level containing licensees, franchise operations, and owned companies for each of the chains of the second level. The licensees, franchise operations, and owned companies of the may then be further divided into the appropriate number of licensees, franchisees and regions, as shown in the fourth level. The fifth level of the hierarchy may then comprise the appropriate members that fall within each of the categories of the fourth level. For example, Licensee A may comprise stores 1 and 2; Licensee B may comprise store 3; franchisee C may comprise stores 4 and 5; franchisee D may comprise store 6; region E may comprise stores 7 and 8; and region F may comprise stores 9 and 10.

In some embodiments, a loyalty offer or promotion, for example, may be offered at any level of a hierarchy. Thus, a $1 off coupon may be offered those stores that are located in a particular geographic location (e.g., particular city, state, region, etc.). Similarly, offers may be based on whether a store is chained-owned or franchisee-owned, for example, or based on the name of the store, for example. Numerous other offer presentation schemes are of course possible.

In some embodiments, rules may be set up to trigger loyalty offers or promotions depending on particulars of a hierarchy(ies). For example, if an identifier or transaction information comes into central reward station 105 from merchant B, loyalty offers or promotions that are designated as being associated with level 2 of hierarchy #1 may be queued for presentation to the customer. Similarly, rules may be set up to interrelate merchants within hierarchies. Thus, a transaction in merchant B may trigger a loyalty offer or promotion redeemable at merchant A, for example.

In some embodiments, consortium-based loyalty offers or promotions may also be offered via the various system and methods described herein. For example, a customer walking into a particular retail store, may be presented with a loyalty offer that may be redeemed at another merchant, such as a restaurant, retail store, or online web site, for example. In some embodiments, a consortium promotion or entity may comprise combining any layer(s) of a hierarchy with any layer(s) another hierarchy to form a single loyalty offer or promotion, for example. Thus, a customer walking into merchant E may be presented with a coupon for redemption at merchant I.

FIG. 4c illustrates examples of consortium-based loyalty offers or promotions that may be used by the systems and methods described herein to generate and present loyalty offers. Consortium #1 may comprise a consortium between merchants B, D and E. Thus, a customer purchasing a product or service, for example, at any of merchant B, D or E may be presented with a loyalty offer that may be redeemed at any of the three merchants, or may be exclusive to any of the three merchants. Consortiums may also cut across different hierarchies. For example, consortium #2 may comprise a consortium between merchants C and I, while consortium #3 may comprise a consortium between merchants G, J, K, P, M, and N. Other consortium-based schemes are possible.

In some embodiments, that various systems and methods described herein may be used to present loyalty offers at a terminal level. For example, if a customer is in the jewelry section of a department store, a different relevant loyalty offers may be presented than if the customer was in the men's department. In some embodiments, a particular terminal within a merchant, for example, may be defined as part of a terminal group that sets forth any number of terminal(s) that are within a particular department within a store, for example. Thus, all check-out terminals in the jewelry department of a store, for example, may be part of a terminal group that may then be associated with particular loyalty offers. Transaction information received from a merchant and which includes terminal information may then be resolved against any number of terminal groups to determine the appropriate loyalty offer(s) to present to the customer. In some embodiments, terminal groups may stand-alone or may be part of a merchant hierarchy.

In some embodiments, the various systems and methods herein may cross-reference the information regarding the product being purchase (e.g., as determined by the product SKU or any other identifier) against the terminal group to make sure that. For example, if a customer purchases a beach ball at the jewelry department terminal the various systems and methods described herein may prevent presentation of loyalty offers that otherwise relate to jewelry transactions, for example.

In some embodiments, the various systems and methods described herein may also monitor cross-selling efforts of merchant employees, for example. Thus, an employee of the jewelry department may be rewarded for cross-selling the products of another department or for volume of sales obtained. In such embodiments, transaction information sent to the central rewards station 105, for example, may include information relating to the identification of the employee and/or the products or sales sold as a result of the employee's efforts. The information collected may then be used to determine appropriate employee rewards (e.g., commissions).

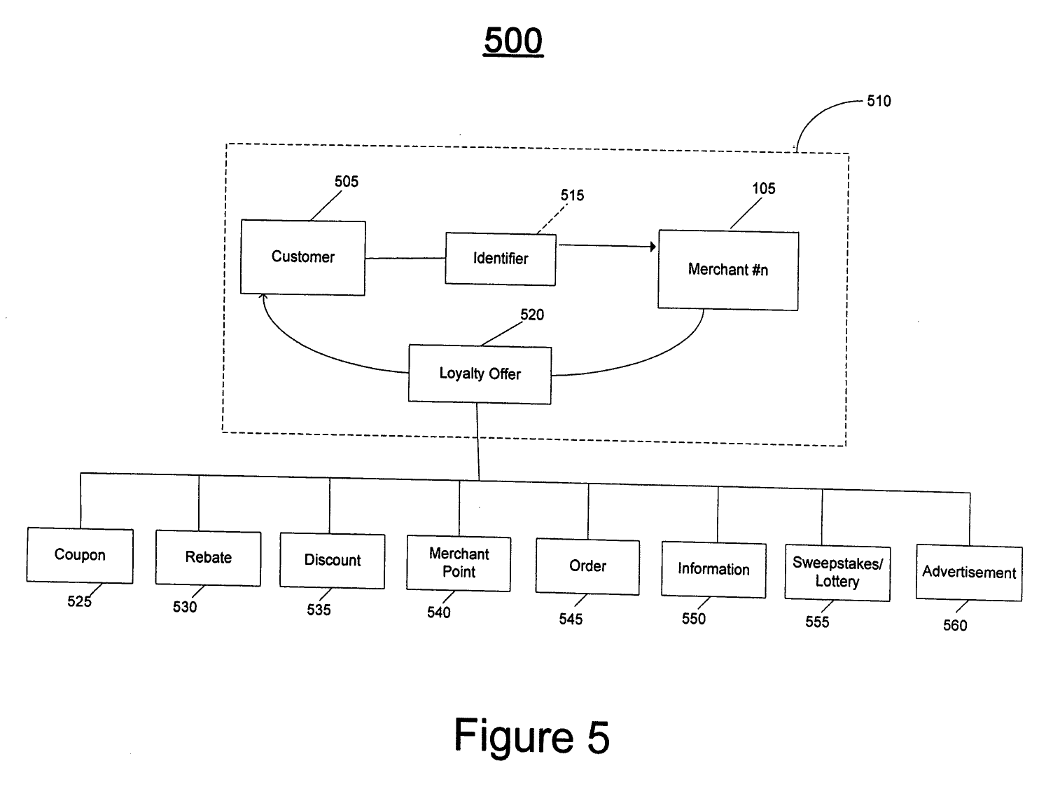

FIG. 5 illustrates a process flow 500 for inducing customer loyalty, according to various embodiments of the invention. As shown, a customer 505 and merchant 105 are conducting a transaction at the merchant's location 510. In some embodiments, merchant location 510 comprises a store or geographic location of the merchant, or an online web site or web page of the merchant. As part of the transaction, the customer 505 may provide the merchant 105 (e.g., either directly to an agent of the merchant or via a POS station 215) an identifier 515 that includes data and information (e.g., customer, merchant reward, and/or general information) that may be used to enhance the customer's experience of the transaction. In some embodiments, the identifier may comprise a credit, debit, gift, smart card, or any other identifier (e.g., biometrics of the customer) that may be used to identify the customer and/or provide data or information that may be used to present relevant loyalty offers. In some embodiments, the identifier is presented by the customer while at the merchant's location. For example, if the customer is at the merchant's store, the identifier may be provided before the customer joins a queue, while the customer is interacting with a sales clerk, or when the customer pays for the transaction. If the customer is interacting with the merchant's web site or web page, then the identifier may be provided via the Internet, or via a card device that may be attached with the terminal the customer is using.

Upon receiving the identifier, the data or information obtained therefrom may be transmitted to central rewards station 105 for resolution against a collection of potential loyalty offers 520 that may be presented to the user. In some embodiments, the data or information obtained via the identifier may be resolved against databases that contain particular loyalty offers that are have been developed by an agent of central rewards station 105. Exemplary loyalty offers that may be presented to a user are coupons 525, rebates 530, discounts 535, merchant points 540, an order 545, information 550, entry in a sweepstakes/lottery 555, or advertisement 560. Each such loyalty offer may be particularly defined by an agent of central rewards station 105, and may be limited for presentation to particular customers and/or merchants. For example, a rebate of 10% off of purchases made at merchant A may be limited for presentation to customers who have frequented merchant A a specified period of times over the past year, for example. Other arrangements are of course possible.

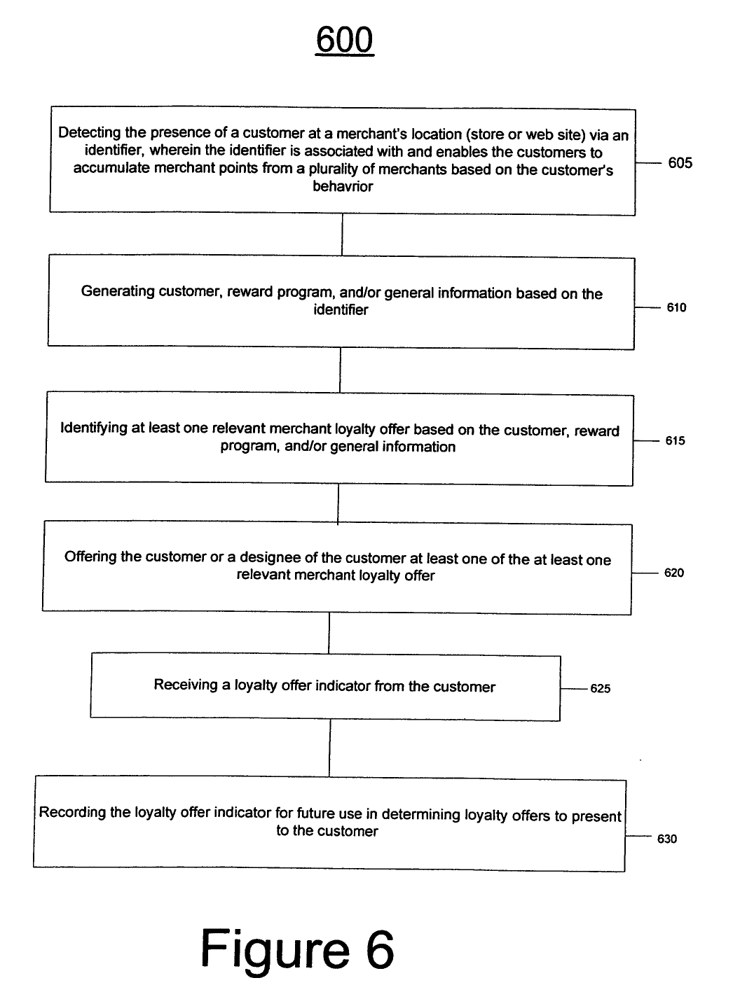

FIG. 6 illustrates a process flow 600 for inducing customer loyalty, according to various embodiments of the invention. At step 605, the presence of a customer at a merchant's location (store or web site) is detected. In some embodiments, detection of a customer may comprise receiving an identifier from the customer when the customer enters the merchant's location (e.g., store or web site). In some embodiments, the identifier is associated with and enables the customer to accumulate merchant points from a plurality of merchants based on the customer's behavior.

At step 610, customer, reward program, and/or general information may be generated based on the identifier. In some embodiments, such customer, reward program and/or general information may come exclusively from the identifier, while in some embodiments, data and information obtained from the identifier (e.g., the name and/or location of the customer) is resolved against a database to determine any or all of the customer, reward program and/or general information.

Data and information obtained via the identifier may, at step 615, be transmitted to central rewards station 105 for determination or identification of at least one relevant merchant loyalty offer based on the information obtained from the identifier and/or the customer, reward program, and/or general information. In some embodiments, such determination or identification is accomplished by resolving the customer, reward program and/or general information against a database of loyalty offers to see which validate. That is, loyalty offers have particular conditions that are met by some or all of the customer, reward program and/or general information. For example, if the customer, reward program and/or general information indicates that the particular customer frequently shops at Merchant A, then a loyalty offer related to the

Once at least one loyalty offer is identified, at step 620, it may be offered or presented to the customer or a designee of the customer at least one of the at least one relevant merchant loyalty offer. In some embodiments, presenting the loyalty offer to the customer may comprise displaying it on a terminal at the merchant's location, printing on a sales receipt or coupon, or having an agent of the merchant present it to the customer verbally.

At step 625, the customer rewards station 105 may receive an indicator from the customer or the merchant indicating whether the customer has accepted (or rejected) the loyalty offer. For example, the customer may respond via a terminal or kiosk, his or her computer or terminal, or by expressing acceptance/rejection of the offer to the salesperson or merchant agent, who in turn communicates the decision to central rewards station 105. Upon receiving the indication, central rewards station 105 may record the indicator for future reference in determining which loyalty offers to present to the customer.

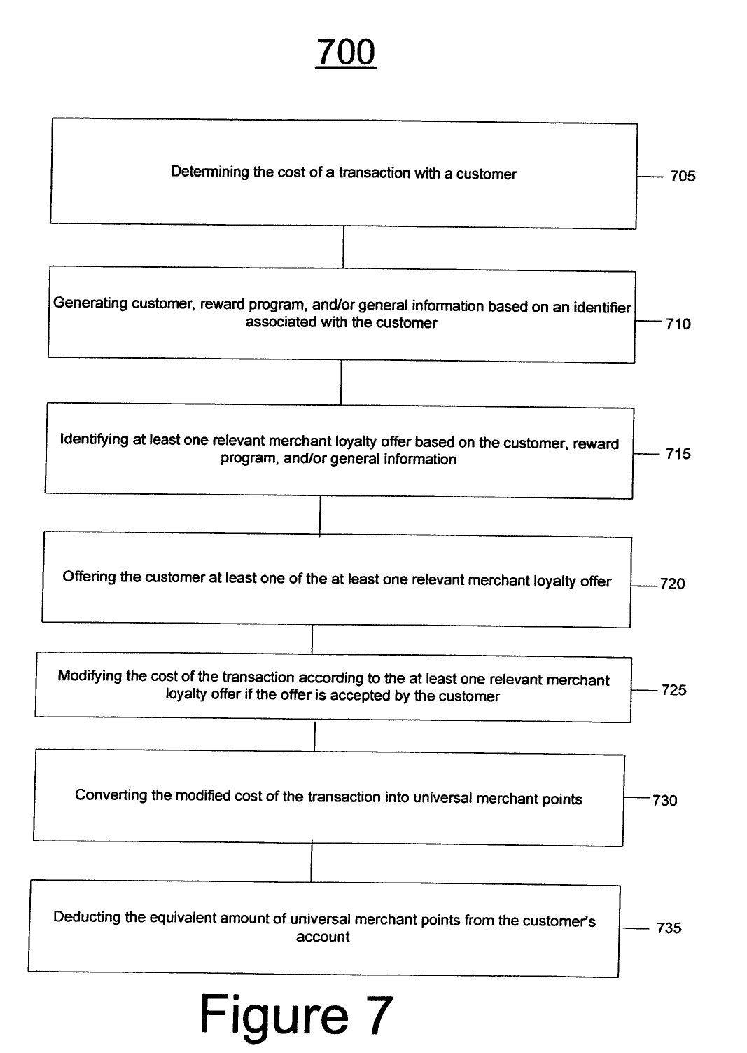

FIG. 7 illustrates a process flow 700 for inducing customer loyalty, according to various embodiments of the invention. At step 705, the cost of a transaction with a customer may be determined. At step 710, customer, reward program, and/or general information based on an identifier associated with the customer may be determined or generated. At step 715, at least one relevant merchant loyalty offer based on the customer, reward program, and/or general information may be identified. At step 720, the customer may be offered at least one of the at least one relevant merchant loyalty offer. At step 725 modifying the cost of the transaction according to the at least one relevant merchant loyalty offer if the offer is accepted by the customer; converting the modified cost of the transaction into universal, client-specific or consortium-based merchant points; and deducting the equivalent amount of universal, client-specific or consortium-based merchant points from the customer's account.

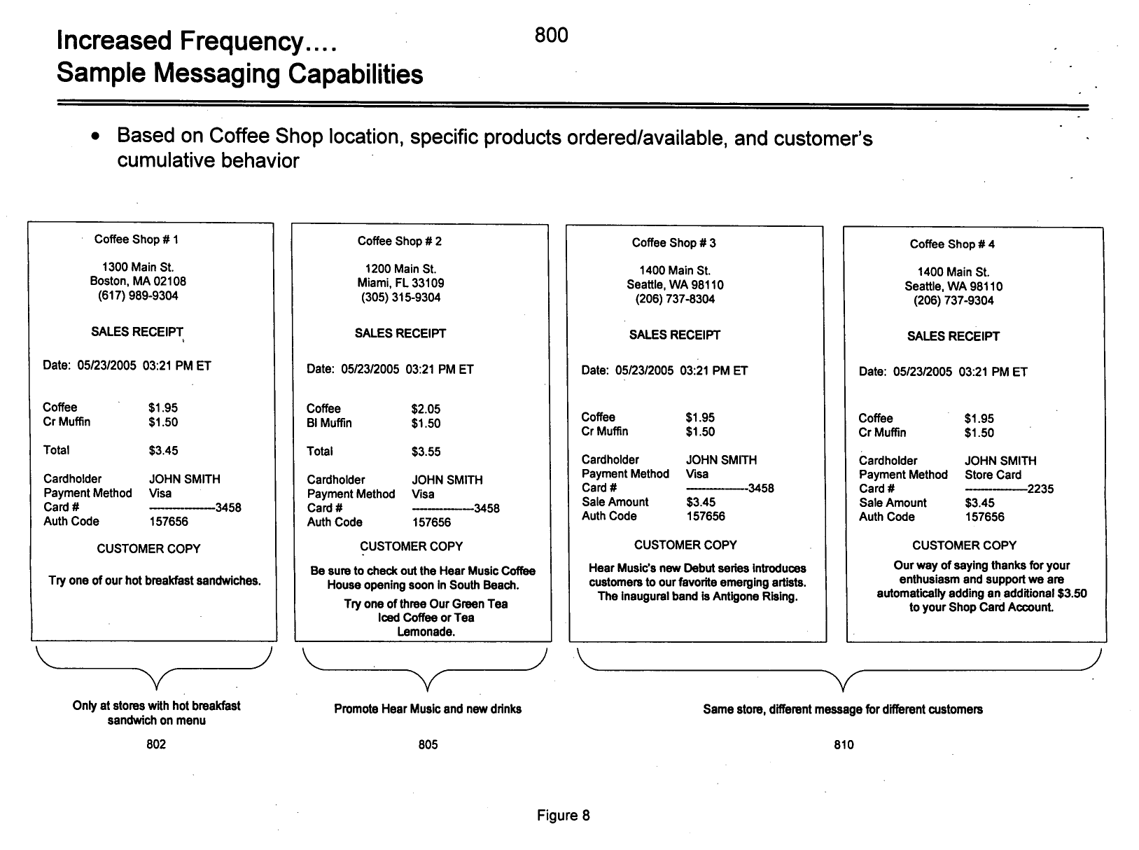

FIG. 8 illustrates various exemplary loyalty offers 800 generated and presented by the systems and methods described herein. In some embodiments, store receipts 802, 805 and 810 present various loyalty offers to the customer according to the system and methods described herein. Receipt 810 presents the general invitation to “Try one of our hot breakfast sandwiches.” Receipt 815 invites the customer to check out the music coffee house opening soon, and try one of several drink offers. Receipts 810 generally mention a new music series, and the addition of $3.50 to the customer's account as a way of saying thanks. Other loyalty offers and methods for presenting them are of course possible.

FIG. 9 illustrates an interface 900 for setting up a loyalty offer for presentation to a customer, according to various embodiments of the invention. Interface 900 illustrates an exemplary GUI for creating a loyalty offer. As shown, the loyalty offer is a promotion applicable on specific days and times—Weekday, 7:00 am-10:00 am, and which targets customers of select cards or identifiers. Other selections or parameters are possible.

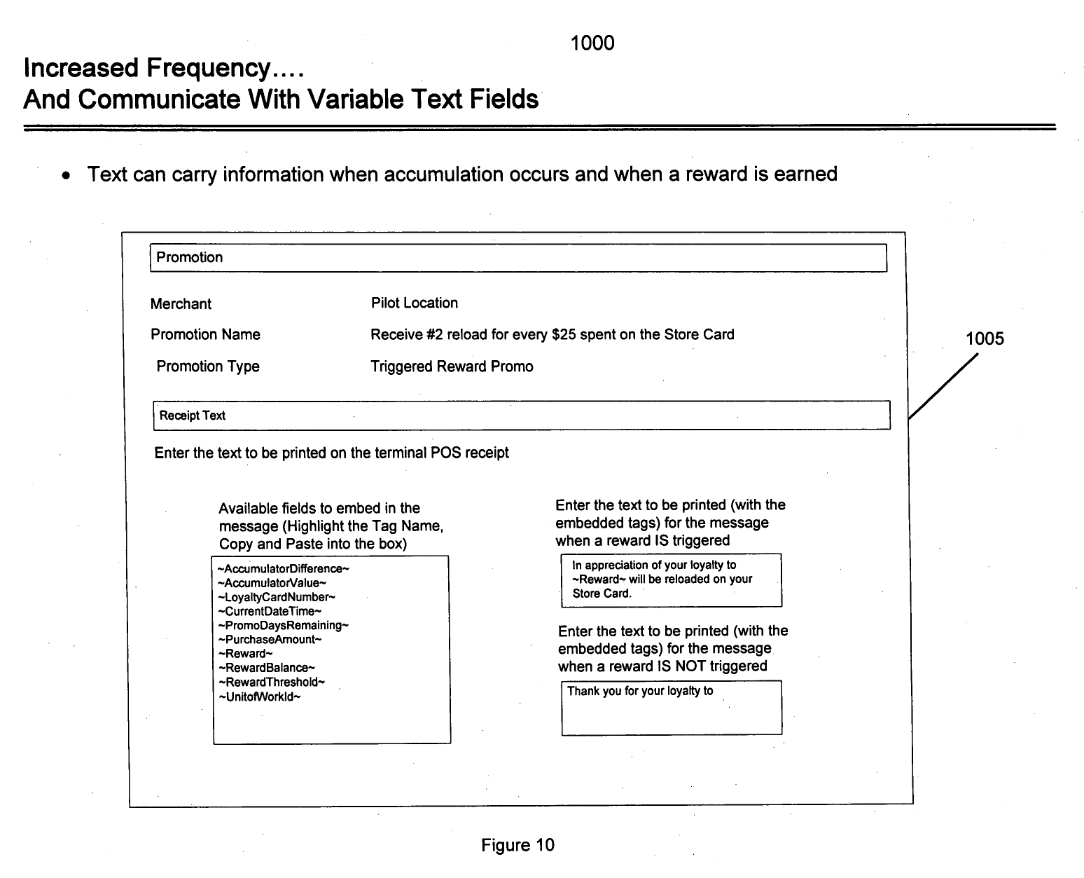

FIG. 10 illustrates an interface 1000 for creating a loyalty offer to be presented to a customer, according to various embodiments of the invention. In some embodiments, FIG. 10 may comprise an application screen interface used to generate the template for a loyalty being presented at POS station 215, for example. That is, interface 1000 may be used to create loyalty offer being presented to a user via POS station 215. In particular, an administrator of central rewards station 105, for example, may interact with interface 1000 and define parameters that may be used to dynamically generate loyalty offers on a per transaction basis (e.g., upon receipt of an identifier from a merchant's location, for example). FIG. 8 illustrates various exemplary loyalty offers that may be generated by the template defined using interface 1000. Other offers are possible.

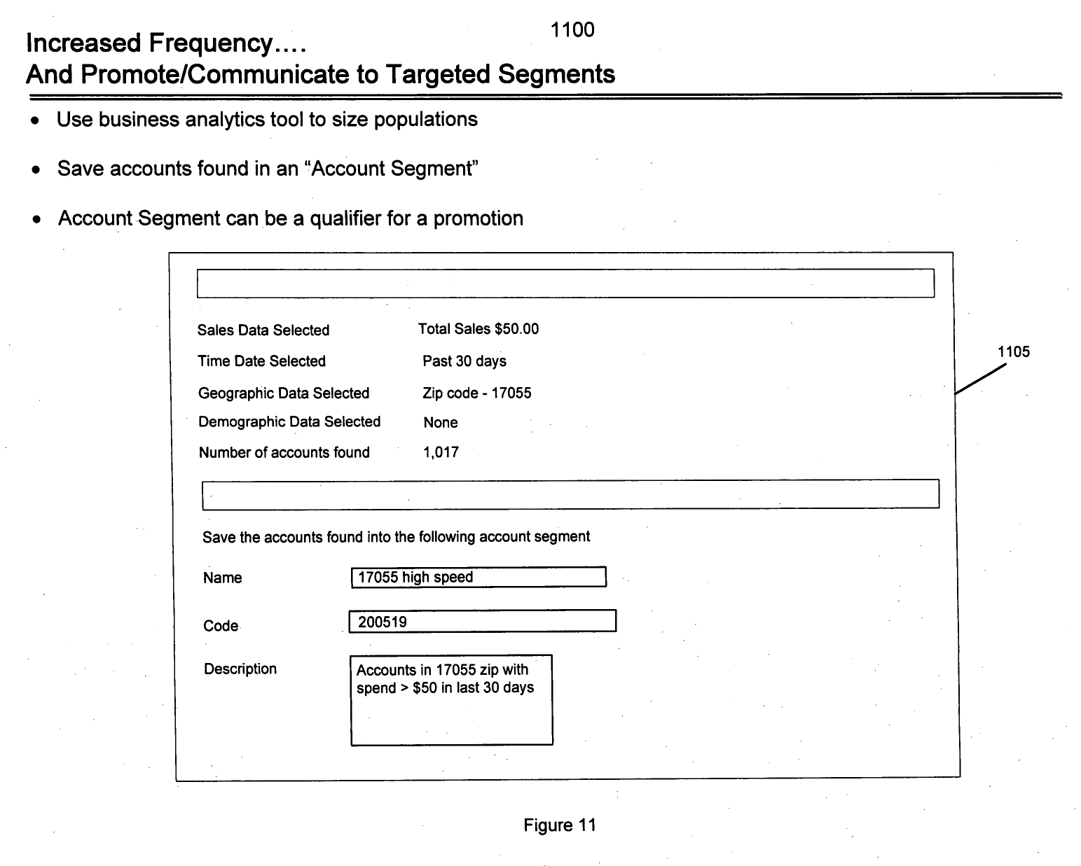

FIG. 11 illustrates an interface 1100 for creating a loyalty offer for presentation to a customer, according to various embodiments of the invention. Interface 1105 demonstrates use of business analytics to size populations, and use of an Account Segment as a qualifier for presentation.

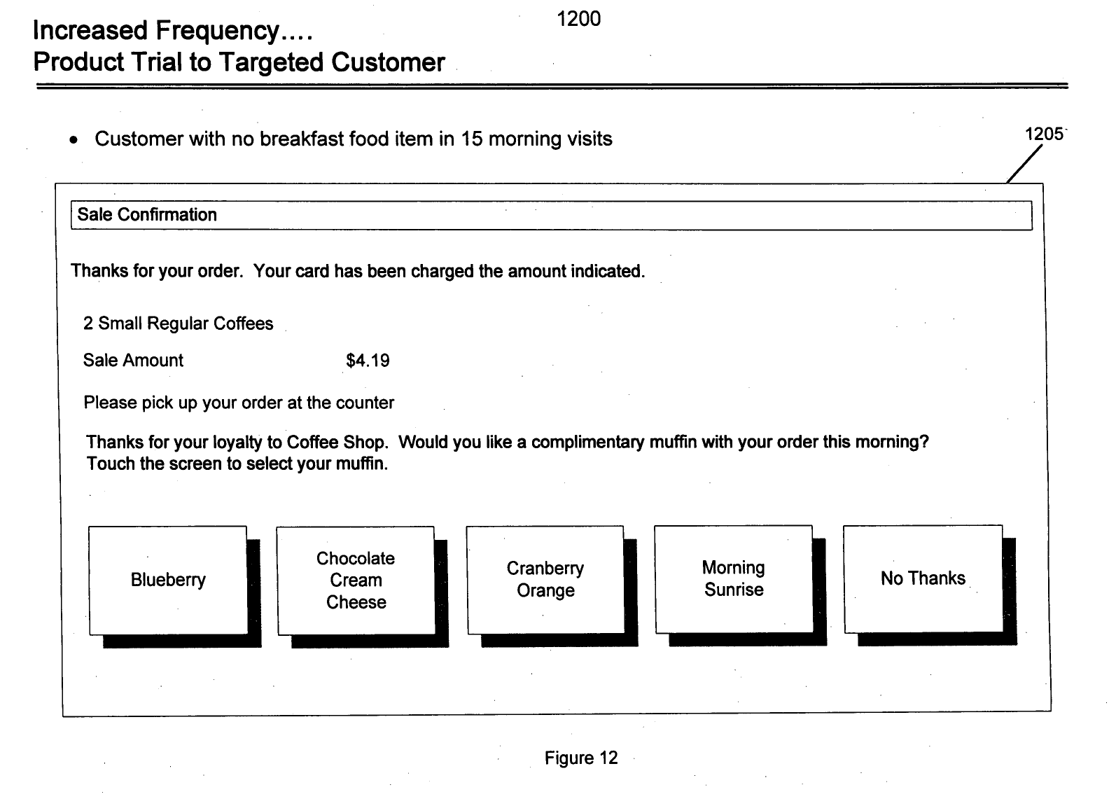

FIG. 12 illustrates an exemplary loyalty offers 1200 generated and presented by the systems and methods described herein. Interface 1205 may comprise a screen that is presented to a customer upon placing an order at a coffee house. Because the customer has not purchased any food in his 15 trips to coffee house. Accordingly, central rewards station 105 may present the customer with a loyalty offer for a free muffin.

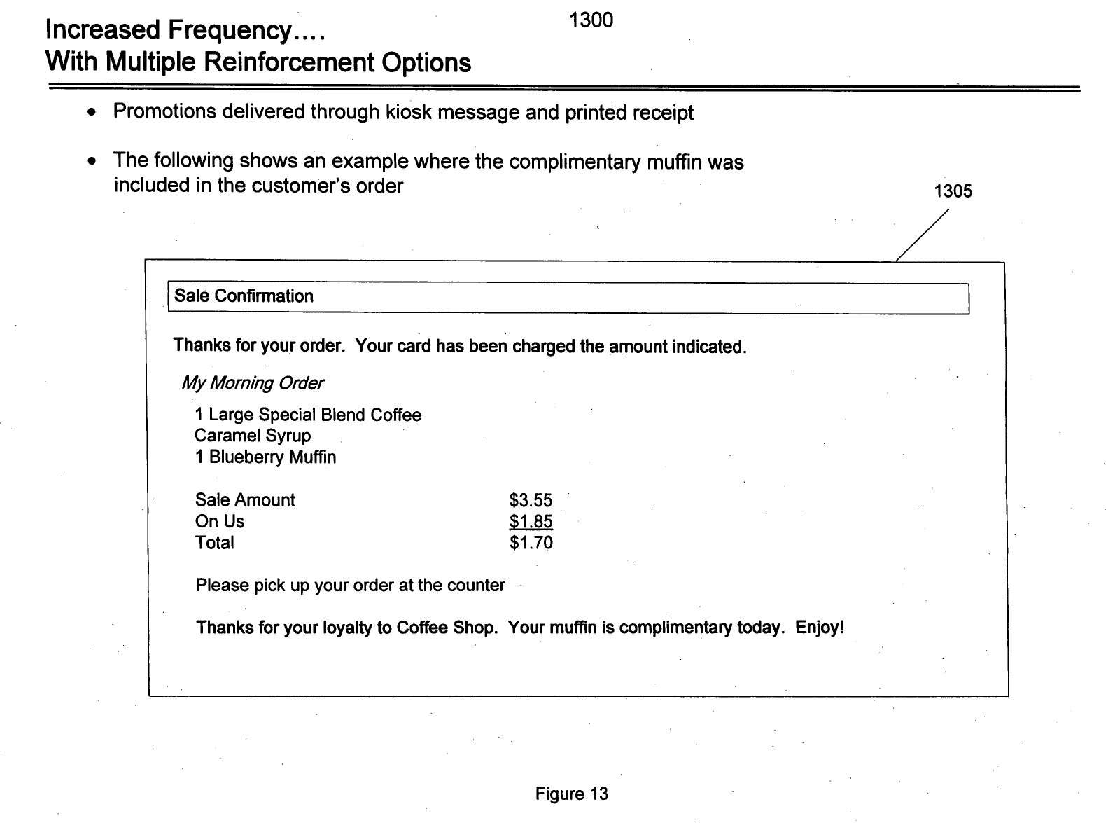

FIG. 13 illustrates an interface 1300 for setting up a loyalty offer for presentation to a customer, according to various embodiments of the invention. Interface 1305 shows a loyalty offer that automatically includes the free muffin in the customer's order.

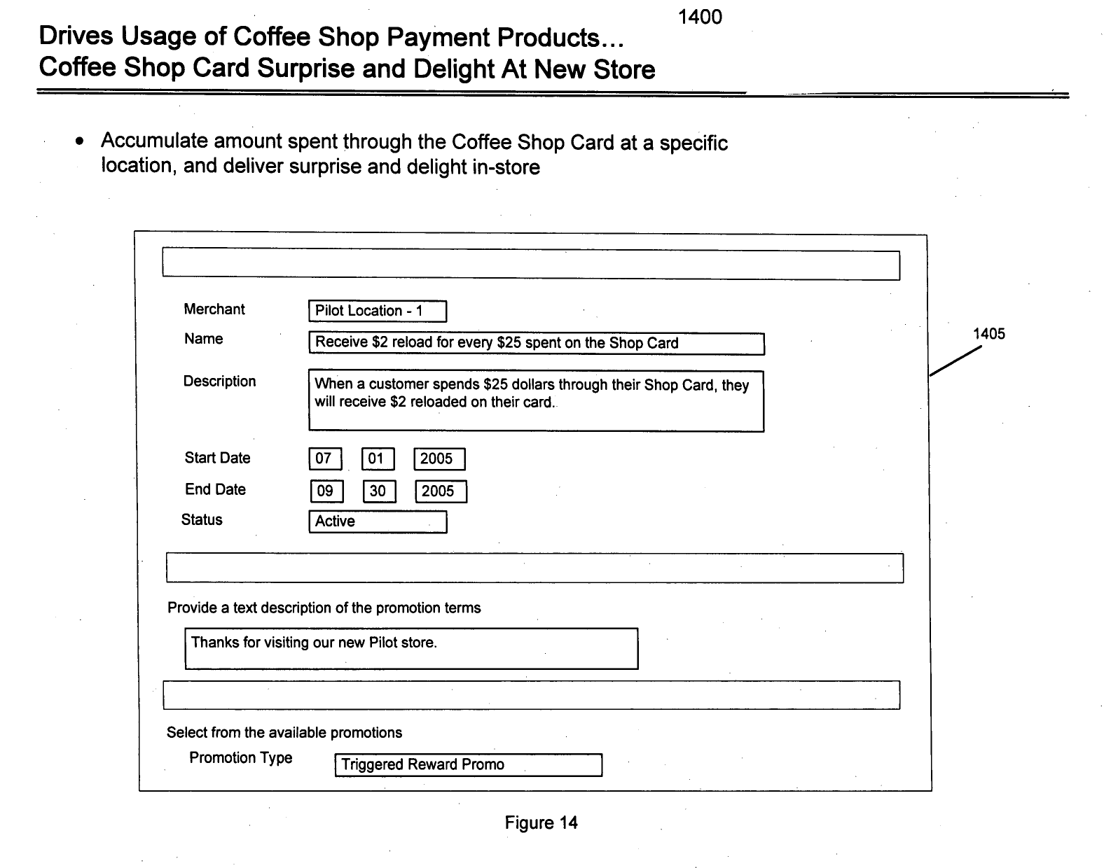

FIG. 14 illustrates an interface 1405 for creating a loyalty offer for presentation to a customer, according to various embodiments of the invention. Interface 1405 shows use of accumulated amount spent through a card or identifier at a specific location resulting in a surprise being delivered to the customer at the store.

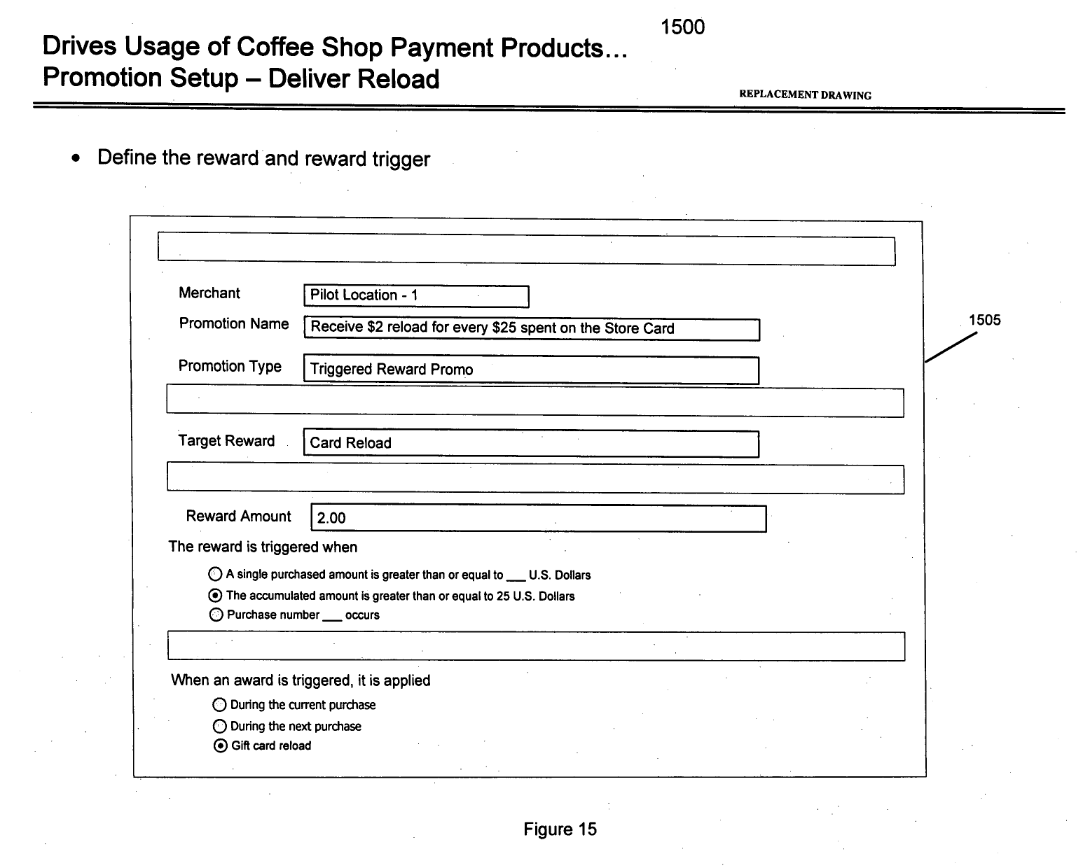

FIG. 15 illustrates an interface 1500 for setting up a loyalty offer for presentation to a customer, according to various embodiments of the invention. Interface 1505 shows the definition of a reward and associated trigger.

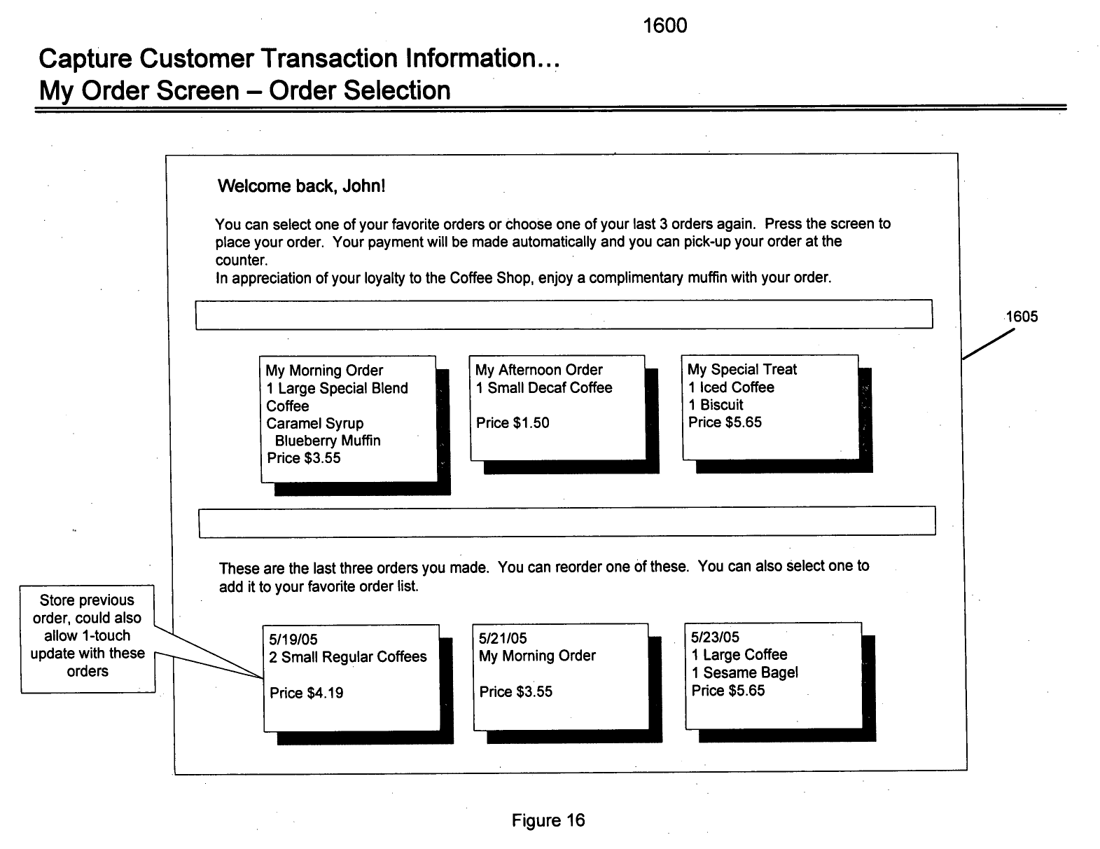

FIG. 16 illustrates an interface 1600 for presenting a loyalty offer to a customer and receiving transaction information from the customer, according to various embodiments of the invention. Interface 1605 presents recent orders that the customer has placed to facilitate his experience at the coffee house, along with a complimentary muffin.

The embodiments of the present inventions are not to be limited in scope by the specific embodiments described herein. For example, although many of the embodiments disclosed herein have been described with reference to specific rewards programs having defined time periods or frequencies, the principles herein are equally applicable to the any type of rewards program having any timing features. In addition, although many of the embodiments disclosed herein have been described with reference to a single physical terminal located inside a merchant store, it should be appreciated that various aspects of the invention may be accomplished when various system components are located elsewhere. For instance, the terminal may monitor customer data, communicate with a central processor, and output reward information from within the customer's own home. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

1. (canceled)

2. The method of claim 25, wherein the customer identifier comprises a card, any biometric data, an RFID device, a bar code, a telephone number, an address, a username and password, or any other alpha-numeric character or sequence thereof.

3. The method of claim 25, wherein the customer identification information comprises a customer's identity; a location of the customer's residence; an identification of one or more of the customer's favorite merchants; an identification of one or more of the customer's favorite or preferred products or services; or at least one demographic particular determined by the merchant.

4-5. (canceled)

6. The method of claim 25, wherein the at least one relevant merchant loyalty offer comprises a coupon; a rebate; a discount; at least one merchant point, an order; an offer to participate in a sweepstakes/lottery program; information about at least one merchant programs or services; or advertisement.

7. The method of claim 25, wherein the merchant offer comprises a consortium-based offer.

8. The method of claim 25, wherein the merchant offer is associated with another merchant.

9. The method of claim 25, further comprising:
receiving, from the customer and via the computing device at the merchant point-of-sale location, an acceptance of the merchant offer.

10. The method of claim 9, wherein the merchant offer is redeemed after the merchant offer is accepted.

11. The method of claim 9, further comprising:
withdrawing the at least one merchant offer for future presentation to the customer.

12. The method of claim 9, further comprising:
recording the merchant offer for future use in determining merchant offers to present to the customer.

13-16. (canceled)

17. The method of claim 29, wherein the identifier comprises a credit card, debit card, store value card, card, account, or any biometric data associated with the customer.

18. The method of claim 29, wherein the identifier comprises a credit card, debit card, store value card, card, account, RFID, or any biometric data associated with the customer.

19. The method of claim 29, wherein the customer identification information comprises a customer's identity; a location of the customer's residence; an identification of one or more of the customer's favorite merchants; an identification of one or more of the customer's favorite or preferred products or services; or at least one demographic particular determined by the merchant.

20-21. (canceled)

22. The method of claim 25, wherein the merchant offer is further determined based on product information as determined by at least one of a SKU number and an Electronic Product Code (EPC).

23. (canceled)

24. The method of claim 27, wherein the hierarchy of merchant offers comprises a combination of one or more layers of a first hierarchy with one or more layers of a second hierarchy.

25. A method for providing a merchant offer to a customer in real-time, comprising:
a computing device at a merchant point-of-sale location detecting the presence of a customer by receiving an identifier that is associated with the customer;
at least one computer processor at a central rewards station that is remotely located from the merchant point-of-sale location and is communicatively coupled to the computing device via a network generating information based on the identifier, the information comprising at least one of customer identification information, reward program information associated with the identifier, and past transaction information using the identifier;
the at least one computer processor at the central rewards station identifying a merchant offer to present to the customer in real-time based on the information; and
the at least one computer processor at the central rewards station offering, via the computing device at the merchant point-of-sale location, the customer the merchant offer.

26. The method of claim 25, wherein the presence of the customer is detected during a customer transaction using the identifier.

27. The method of claim 25, wherein the merchant offer comprises a hierarchy of merchant offers.

28. A system for remote data access of customer loyalty information, said data being used to locally display a loyalty offer, comprising:
a computing device at a merchant point-of-sale location that detects the presence of a customer by receiving an identifier that is associated with the customer;
an information generation processor at a central rewards station that is remotely located from the merchant point-of-sale location that generates information based on the identifier, the information comprising at least one of customer identification information, reward program information associated with the identifier, and past transaction information using the identifier;
an identification processor at central rewards station identifying a merchant offer to present to the customer in real-time based on the information; and
an offer processor at the central rewards station that offers, via the computing device at the merchant point-of-sale location, the customer the merchant offer.

29. A method for remote data access of customer loyalty information, said data being used to locally display a loyalty offer, comprising:
a computing device at a merchant point-of-sale location receiving a transaction request for a transaction with a customer, the transaction request comprising a transaction amount and an identifier that is associated with the customer;
at least one computer processor at a central rewards station that is remotely located from the merchant point-of-sale location and is communicatively coupled to the computing device via a network generating information based on the identifier, the information comprising at least one of customer identification information, reward program information associated with the identifier, and past transaction information using the identifier;
the at least one computer processor at the central rewards station identifying a merchant offer to present to the customer in real-time based on the information and the transaction;
the at least one computer processor at the central rewards station offering, via the computing device at the merchant point-of-sale location, the customer the merchant offer;
receiving, from the customer and via the computing device at the merchant point-of-sale location, an acceptance of the merchant offer;
the at least one computer processor at the central rewards station modifying the transaction amount according to the merchant offer if the offer is accepted by the customer;
the at least one computer processor at the central rewards station converting the modified amount of the transaction into universal, client-specific or consortium-based merchant points;
the at least one computer processor at the central rewards station deducting the equivalent amount of universal, client-specific or consortium-based merchant points from an account of the customer.

30. A system comprising:
at least one computer processor; and
an executable computer program that is tangibly embodied on a nontransitory computer readable medium, which causes the at least one computer processor to perform the following:
detect the presence of a customer by receiving an identifier that is associated with the customer;
generate information based on the identifier, the information comprising at least one of customer identification information, reward program information associated with the identifier, and past transaction information using the identifier;
identify a merchant offer to present to the customer in real-time based on the information; and
offer, via the computing device at the merchant point-of-sale location, the customer the merchant offer.

31. A system for remote data access of customer loyalty information, said data being used to locally display a loyalty offer, comprising:
a detection processor that detects the presence of a customer by receiving an identifier that is associated with the customer;
an information generation processor at a central rewards station that is remotely located from the merchant point-of-sale location that generates information based on the identifier, the information comprising at least one of customer identification information, reward program information associated with the identifier, and past transaction information using the identifier
an identification processor at central rewards station identifying a merchant offer to present to the customer in real-time based on the information;
an offer processor at the central rewards station that offers, via a computing device at the merchant point-of-sale location, the customer the merchant offer;
a transaction module that processes transactions between a customer and a merchant; and
a merchant points conversion processor that converts merchant reward points to reduce a transaction amount.
